(19) United States
(12) Patent Application Publication
(10) Pub. No.: US 2026/0296967 A1
(43) Pub. Date: Oct. 1, 2026

(54) Recycled Concrete Aggregates Carbonation Treatment

(71) Applicants: Hawkins Construction Company, Omaha, NE (US); NUtech Ventures, Lincoln, NE (US)

(72) Inventors: Chris Hawkins, Omaha, NE (US); Jim Ball, Omaha, NE (US); Nate Harper, Omaha, NE (US); Seunghee Kim, Omaha, NE (US); Jiong Hu, Omaha, NE (US); Amin Hosseini Zadeh, Omaha, NE (US); Miras Mamirov, Omaha, NE (US)

(73) Assignees: Hawkins Construction Company, Omaha, NE (US); NUtech Ventures, Lincoln, NE (US)

(21) Appl. No.: 19/699,396

(22) Filed: Jun. 5, 2026

Related U.S. Application Data
(62) Division of application No. 18/160,752, filed on Jan. 27, 2023.
(60) Provisional application No. 63/304,184, filed on Jan. 28, 2022.

(51) Int. Cl. C04B 18/167; C04B 20/02; C04B 26/26; C04B 28/04; C04B 40/00; C04B 111/00

(52) U.S. Cl. CPC C04B 18/167; C04B 20/0232; C04B 26/26; C04B 28/04; C04B 40/0071; C04B 2111/00019

(57) ABSTRACT

A method of treating recycled concrete aggregates (RCA) that includes constructing a chamber configured to form a hermetic seal, loading the RCA into the chamber, hermetically sealing the chamber, pressurizing the interior of the chamber with carbon dioxide gas, monitoring a pressure and a relative humidity in the interior of the chamber, and controlling the pressure and the relative humidity until a predetermined condition is met.

### CROSS-REFERENCE TO RELATED APPLICATIONS

This patent application claims the benefit of U.S. Provisional Patent Application No. 63/304,184, filed Jan. 28, 2022, and is a divisional of U.S. patent application Ser. No. 18/160,752, filed Jan. 27, 2023, herein incorporated by reference in their entirety.

### BACKGROUND

As the construction and repair of infrastructures continues, demands for sands, gravels, rocks, and concretes are rising to a great extent, which are consuming tremendous natural resources every year. For example, the annual demand for aggregates is estimated to be more than 1,800 million tons (1.6×10¹² kg) in the U.S. Moreover, a huge volume of construction and demolition (C&D) wastes is being generated every year, particularly waste concrete. Concrete accounts for approximately 70% of the entire commercial demolition debris. In the meantime, landfill costs are continuing to increase. In this regard, recycle and reuse of waste concrete may significantly help to address these challenges.

One of the most promising ways to reuse such waste concrete may be to produce recycled concrete aggregates (RCA) via crushing and sieving. RCA is a popular replacement for natural stone aggregates for parking lots, backfills, home landscapes, and the like. However, the mechanical properties of RCA may be inferior to natural aggregate due to a large amount of inherited residual paste and previous heavy use including weatherization. Further, there may be an environmental concern about using RCA due to potential contamination caused by the leachate of heavy metals and a high pH. For instance, one research group showed high alkalinity and concentration of heavy metals of RCA leachate via lab and field tests. The above-mentioned issues greatly limited the effective usage of RCA in state or local agencies. Additionally, RCA can potentially compromise groundwater quality. Therefore, there may be a critical need to develop a means of improving the mechanical properties of RCA while addressing the environmental concern about using RCA.

### SUMMARY

One or more aspects of the present disclosure provides a method of treating recycled concrete aggregates (RCA) includes: constructing a chamber configured to form a hermetic seal; loading the RCA into the chamber; hermetically sealing the chamber; pressurizing the interior of the chamber with carbon dioxide gas; monitoring a pressure and a relative humidity in the interior of the chamber; and controlling the pressure and the relative humidity until a predetermined condition is met.

One or more aspects of the present disclosure provides treated recycled concrete aggregates (RCA) that includes: RCA that have been loaded into and hermetically sealed within a chamber; and treating the RCA by exposing the RCA to a carbon dioxide-enriched atmosphere at elevated pressure within the chamber, a temperature and a relative humidity of the atmosphere having been monitored and controlled until a predetermined condition is met, where treating the RCA changes the proportion of constituting minerals in the RCA, increasing the percentage of calcium carbonate and silica as a result of reactions between calcium hydroxide and calcium silicate hydrate and carbon dioxide.

One or more aspects of the present disclosure provides a method of carbonation of recycled concrete aggregates (RCA). The method includes: constructing a chamber configured to form a hermetic seal, loading the RCA into the chamber; hermetically sealing the chamber; pressurizing the interior of the chamber with carbon dioxide gas; monitoring a pressure, a temperature, and a relative humidity in the interior of the chamber; and controlling the pressure, the temperature, and the relative humidity until a predetermined condition is met.

One or more aspects of the present disclosure provides a system for treating recycled concrete aggregates (RCA). The system includes: a chamber configured to form a hermetic seal, the chamber comprising: a volume of at least 10 L and no greater than 3×10⁴ L; a door configured to form a hermetic seal; at least one dehumidifier installed in the chamber and configured to maintain a relative humidity in the chamber; at least one system installed in the chamber and configured to collect water from the at least one dehumidifier; at least one fan installed in the chamber and configured to circulate CO₂ gas and moisture within the chamber; at least one heating element; at least one pressure sensor installed and configured to measure a pressure within the chamber; at least one relative humidity/temperature sensor installed and configured to measure a relative humidity and a temperature within the chamber; a supply of carbon dioxide gas operatively connected to the chamber via an injection valve; and an ejection valve installed on the chamber and configured to allow gas to exit the chamber.

### BRIEF DESCRIPTION OF THE DRAWINGS

FIG. 1 shows a chamber for carbonating RCA in accordance with one or more embodiments.

FIGS. 2A and 2B show two laboratory chambers for carbonating RCA in accordance with one or more embodiments.

FIG. 3 shows a sealed bucket for leaching tests in accordance with one or more embodiments.

FIG. 4 shows a sample identification system in accordance with one or more embodiments.

FIG. 5 shows a bar graph of all measured aggregate crushing values in accordance with one or more embodiments.

FIGS. 6A and 6B show bar graphs of LA abrasion mass loss in accordance with one or more embodiments.

FIG. 7 shows bar graphs of LA abrasion mass loss in accordance with one or more embodiments.

FIGS. 8A and 8B show bar graphs of freeze-thaw mass loss in accordance with one or more embodiments.

FIG. 9 shows bar graphs of freeze-thaw mass loss in accordance with one or more embodiments.

FIG. 10 shows a bar graph of compressive strengths of concrete samples in accordance with one or more embodiments.

FIG. 11 shows a bar graph of the module of ruptures of concrete samples in accordance with one or more embodiments.

FIG. 12 shows a bar graph of the module of plasticity and Poisson's ratio of concrete samples in accordance with one or more embodiments.

FIG. 13 shows a bar graph of surface resistivity and bulk resistivity of concrete samples in accordance with one or more embodiments.

FIGS. 14A and 14B show plots of carbon dioxide mass per RCA mass as functions of time for different pressures in accordance with one or more embodiments.

FIG. 15 shows a plot of carbon dioxide mass per RCA mass as a function of time for different pressures in accordance with one or more embodiments.

FIGS. 16A and 16B show plots of carbon dioxide mass consumption and carbon dioxide mass per RCA mass as functions of time for different pressures in accordance with one or more embodiments.

FIGS. 17A and 17B show plots of carbon dioxide mass consumption and carbon dioxide mass per RCA mass as functions of time for different pressures in accordance with one or more embodiments.

FIGS. 18A and 18B show plots of carbon dioxide mass consumption and carbon dioxide mass per RCA mass as functions of time for different relative humidities in accordance with one or more embodiments.

FIGS. 19A and 19B show plots of carbon dioxide mass consumption and carbon dioxide mass per RCA mass as functions of time for different temperatures in accordance with one or more embodiments.

FIGS. 20A and 20B show plots of carbon dioxide mass consumption and carbon dioxide mass per RCA mass as functions of time for different relative humidities in accordance with one or more embodiments.

FIGS. 21A and 21B show plots of carbon dioxide mass consumption and carbon dioxide mass per RCA mass as functions of time for different sample pre-conditioning in accordance with one or more embodiments.

FIG. 22 is a flowchart of a method of treating recycled concrete aggregates in accordance with one or more embodiments.

### DETAILED DESCRIPTION

Applicants investigated improving mechanical and chemical properties of older concrete aggregates via an introduction of carbon dioxide (CO₂). Experiments were performed in a laboratory setting and with a mid-scale prototype chamber developed and tested for suitability for the experiments. The chamber is constructed to treat approximately one ton (910 kilograms (kg)) loose-volume, source-controlled RCA, although chambers, systems, methods, and products produced disclosed herein are not intended to require source-controlled RCA. After approximately 40 tests using the prototype chamber and approximately 30 tests in the laboratory, applicant has demonstrated the efficacy of aggregate improvement by carbon dioxide treatment process.

Treating RCA with carbon dioxide (CO₂) changes the proportion of constituting minerals in the RCA, increasing the percentage of calcium carbonate (CaCO₃) and silica (SiO₂) as a result of reactions between calcium hydroxide (Ca(OH)₂) and calcium silicate hydrate (C—S—H), and carbon dioxide (CO₂).

The long-term implications of this research are potentially immense. The present disclosure may have the potential to disrupt the $19 billion stone aggregate industry in an environmentally positive manner. By improving RCA to higher-value uses, the treated RCA described herein may be diverted from landfills (end of life concrete is, by volume, the single largest landfill product in the United States). The treated RCA is a sustainable and the disclosed method may provide substantial carbon sequestration. The use of RCA as an alternative to virgin material may extend the life of quarries, lessening the burden on natural habitat. Further, reduction of pH and heavy metals in the leachate of RCA may protect groundwater.

One of the most promising ways to reuse such waste concrete may be to produce recycled concrete aggregates (RCA) via crushing and sieving. RCA is a popular replacement for natural stone aggregates for parking lots, backfills, home landscapes, and the like. However, the mechanical properties of RCA may be inferior to natural aggregate due to a large amount of inherited residual paste and previous heavy use including weatherization. Further, there may be an environmental concern about using RCA due to potential contamination caused by the leachate of heavy metals and a high potential of hydrogen ions (pH). For instance, one research group showed high alkalinity and concentration of heavy metals of RCA leachate via lab and field tests. The above-mentioned issues greatly limited the effective usage of RCA in state or local agencies. Additionally, RCA can potentially compromise groundwater quality. Therefore, there may be a critical need to develop a means of improving the mechanical properties of RCA while addressing the environmental concern about using RCA.

### Laboratory Investigation

A total of twenty-seven separate laboratory-scale carbon dioxide-treatments have been implemented using two treatment chambers with a capacity of 10 liters (L) and 30 L. In particular, the effect of main variables, including carbon dioxide supply pressure, relative humidity (RH), treatment temperature, initial gas conditioning (CO₂-vacuum vs. CO₂-purge), and sample pre-conditioning methods, on the carbon dioxide consumption for the treatment of RCA were investigated in depth. The mechanical and pH test results confirmed that the RCA samples were properly carbonated by carbon dioxide. The calculated carbon dioxide mass consumption reveals that the consumption will increase with the initial carbon dioxide supply pressure, time of exposure, and temperature. Moreover, the test results imply that the optimum RH to achieve the maximum carbon dioxide consumption may be in the range of 50±10%, and particularly 50±5%. The mechanical improvement of RCA was observed to be more salient in the treatment chamber with a higher capacity (30 L) due to the higher volume of the supplied carbon dioxide.

### Fabrication of the Commercial-Scale Prototype

A mid-scale carbon dioxide treatment chamber 100 with a capacity of 500 gallons (1.9 cubic meters (m³)) was fabricated as a commercial-scale prototype. The prototype chamber 100 was 116 inches in length (L) and 38½ inches in height (H). Commercial chambers may have volumes of 1000 cubic feet (28,000 liters) or more. As one example, a commercial chamber may be 8 feet in diameter (or height) and 20 feet in length. The chamber 100 is equipped with pressure 116 and relative humidity/temperature (RH/T) 118 sensors, gas injection 124 and ejection 126 valves, rails to accommodate RCA baskets, a water collection container 114, a fan 122, and a dehumidifying system 112. The dehumidifying system can be a conventional dehumidifier, a desiccant-type dehumidifier, or some other suitable system. The chamber door 102 is designed to facilitate the loading and unloading of RCAs and be airtight to prevent any carbon dioxide leakage during the treatment of RCAs.

### Carbon Dioxide Treatment of RCA Using the Prototype

A total of thirty-five separate carbon dioxide treatments of RCAs were conducted at various conditions using the prototype. Tested conditions included carbon dioxide pressure, carbon dioxide supply condition, RCA loading arrangement (simple loose loading vs. separated loading in baskets to ensure a better contact with CO₂), RCA volume, treatment time, temperature, and RCA's initial water content to ascertain the effect of each variable on carbon dioxide consumption and consequent mechanical and environmental improvements of carbon dioxide-treated RCAs.

Tested conditions included carbon dioxide pressure: 1, 5, 10, 20, 40, and 60 pounds per square inch gauge (psig, 6.9, 34.5, 68.9, 138, 276, and 414 kilopascals (kPa), respectively); carbon dioxide supply: initial set pressure vs. continuous carbon dioxide supply; loading arrangement: in baskets vs. simple loose load; RCA volume: 10% vs. 20% of the inside chamber volume; treatment time: from 1 hour to 24 hours; and RCA's initial water content: with normal dryness vs. extra drying. Higher pressures (for example, 80 psig or greater) are desirable. Additional tests were conducted at 80 psig (552 kPa) until the chamber seal failed. A wide range of carbon dioxide mass consumption and mechanical-environmental test results have been obtained using those diverse variables. Analysis of test results reveals the most effective and optimum parameter ranges.

### Mechanical and Environmental Tests of Carbon Dioxide-Treated RCA Using the Prototype

Five different mechanical and two environmental-related tests were conducted using the original and carbon dioxide-treated RCAs. In detail, twenty-two separate tests of specific gravity and absorption capacity, one hundred and seventeen individual tests of the aggregate crushing value (ACV) index, twenty-three tests of Los Angeles (LA) abrasion resistance, and twenty-three tests of freeze-thaw (F-T) resistance were conducted on the carbon dioxide-treated RCAs using the fabricated prototype. In addition, thirty-six individual phenolphthalein tests and more than one hundred and fifty leachate water tests were conducted to investigate the pH and the concentration of heavy metals in the leachate of the carbon dioxide-treated RCAs.

The mechanical properties show a wide range of improvements: ACV improvement up to approximately 20%, LA abrasion mass loss improvement up to approximately 16%, and F-T mass loss improvement up to approximately 59%. All carbon dioxide-treated RCAs were observed to satisfy the requirement to replace natural aggregates (that is, less than 40% and 45% mass loss by abrasion for concrete and base course, respectively, per AASHTO T96 and NDOT Spec 1033.02). A base course refers to an underlayment of rock, perhaps 4-6 inches (10-15 centimeters (cm)), to allow water to drain through. Moreover, the concrete specimens mixed with carbon dioxide-treated RCAs meet the requirement to replace natural aggregates in terms of the minimum strength of 3,500 pounds per square inch (psi, 24 megapascals (MPa), minimum modulus of rupture of 600 psi (4 MPa), and F-T resistance.

For the environmental aspect, the pH of leachate water was decreased up to two pH units while the concentration of heavy metals dropped more than 50% compared to that of the original RCA after 24 hours of submersion for various carbon dioxide treatment conditions. It is worth noting that most of the heavy metal concentration levels in the collected leachate water were far below the EPA's maximum contaminant level (MCL) for drinking water.

All small-scale and mid-scale carbon dioxide-treatment data, as well as mechanical and environmental test results, were compiled and analyzed in detail. Below, the results of each variable are first described, followed by the combined variable ranges.

Carbon dioxide pressure: A wide range of carbon dioxide pressure was studied from gauge pressures of 1 psig to 60 psig (6.9 kPa to 410 kPa). The test results indicated that the carbon dioxide consumption is much faster at higher carbon dioxide pressure. The ACV test results did not show a strong correlation between strength increase and CO₂ pressure. It may be that the ACV index is more relevant to the bulk property of RCAs. The mass loss after the LA abrasion and F-T resistance tests showed a very good correlation with carbon dioxide pressure, thus carbon dioxide consumption. The pH of leachate water was also reduced more with higher carbon dioxide pressure for the RCA treatment. Lastly, the concentration of heavy metals did not show a strong correlation with the carbon dioxide pressure. However, all of the heavy metal concentrations remained far below the EPA's maximum contaminant level (MCL) for drinking water. Among the test results, the F-T mass loss showed the strongest correlation with the CO₂ consumption, with a P-value of about 0.035 from the statistical regression analysis. This is a notable result, as F-T mass loss is one of the most important indicators of aggregate durability. It may be that higher CO₂ pressure could induce faster carbonation of RCAs with a higher degree of penetration inside the aggregates. Furthermore, the test results imply that the suggested treatment approach is most effective on the surface-level mechanical properties improvement of RCAs.

Treatment time: Various treatment times were examined, ranging from 1 hour to 24 hours. Based on the carbon dioxide consumption results for both mid- and laboratory-scale tests, it was observed that the treatment time might be divided into three zones as follows: 0-6 hours: the fastest rate of carbon dioxide-treatment of RCAs, 6-12 hours: moderate rate, and 12-24 hours: slow treatment rate. Therefore, the most effective time for the treatment process may be within 12 hours, particularly the first 6 hours. The mass loss of the LA abrasion and F-T resistance tests showed a good relationship with the treatment time. The statistical regression analysis shows that all mechanical tests—ACV, LA abrasion, and F-T resistance—are statistically highly dependent on the treatment time (P-value of approximately 0.003, 0.040, and 0.0001, respectively). Overall, the treatment time may be another important factor that can significantly affect the carbon dioxide-treatment process.

RCA mass: Two different RCA masses were evaluated using the mid-scale prototype, 10% and 20% of the total volume of the treatment chamber (that is, about 260 kg (570 pounds (lb)) and 730 kg (1610 lb), respectively). Two different RCA masses were also tested in the laboratory-scale treatment chamber with the amounts of 1.2 kg and 5 kg. In theory, the higher mass (thus, volume) of the RCAs could reduce the volume that carbon dioxide can occupy and could decrease the contact between RCAs and carbon dioxide inside the chamber. The primary finding here is that airflow of carbon dioxide between aggregates is important.

Relative humidity: The effect of RH on the carbon dioxide consumption, a mass gain of RCAs, and ACV was examined in depth using the laboratory-scale treatment chamber (30 L). A wide range of RH levels (from approximately 2% to approximately 80%) was tested. The data analysis suggests that the maximum carbon dioxide consumption may be achieved with the RH between 50% and 55%. The mass gain of RCAs after the carbon dioxide treatment also showed a higher gain for the RH of 50±5%. The ACV index did not show a strong correlation, but in general, the ACV index showed the best improvement with the RH in the range of 50% and 55%. In this regard, the optimum RH range may be 505%.

Treatment temperature: The effect of treatment temperature, within the limited range, was studied primarily in the lab. The test results indicated an improvement in the carbon dioxide consumption at higher temperatures. The mass gain of RCAs after carbon dioxide treatment also showed a higher percentage of gain with a higher treatment temperature, while the ACV index did not show a strong dependency on treatment temperature. From the geochemistry point of view, the treatment temperature may play an important role by accelerating/decelerating the chemical reactions.

Pre-conditioning (initial moisture content as mass percent): The pre-conditioning for the mid-scale treatments was kept similar (as it is, 3-5%) for all conducted tests. Despite such a narrow range of the initial moisture content (that is, the moisture content before going into the chamber), the F-T resistance showed a good correlation with it (P-value=0.0016) from the statistical regression analysis. That is, the F-T resistance tests yielded smaller mass loss with the lower initial moisture content. Theoretically, the amount of initial water content may play an important role in the carbonation process. That is, moisture may be needed for initiating any chemical reactions, though, a high amount of water may deter carbon dioxide penetration into RCAs and, thus, the carbonation process. In this regard, pre-conditioning RCAs at an optimum moisture level may be another important factor.

Based on the observed results of all test variables, the optimum ranges of test variables may be summarized as shown in Table 1.

TABLE 1
General optimum treatment variables based on experimental results

| CO₂ treatment parameters | Optimum range |
|---|---|
| CO₂ pressure [psig] | 20-80 |
| Treatment time [hr] | 4-12 |
| Relative humidity [%] | 50 ± 10% |
| Temperature [° C.] | 25 ± 5 |
| Initial moisture | As in the field |

### Fabrication of Carbon Dioxide Treatment Chamber

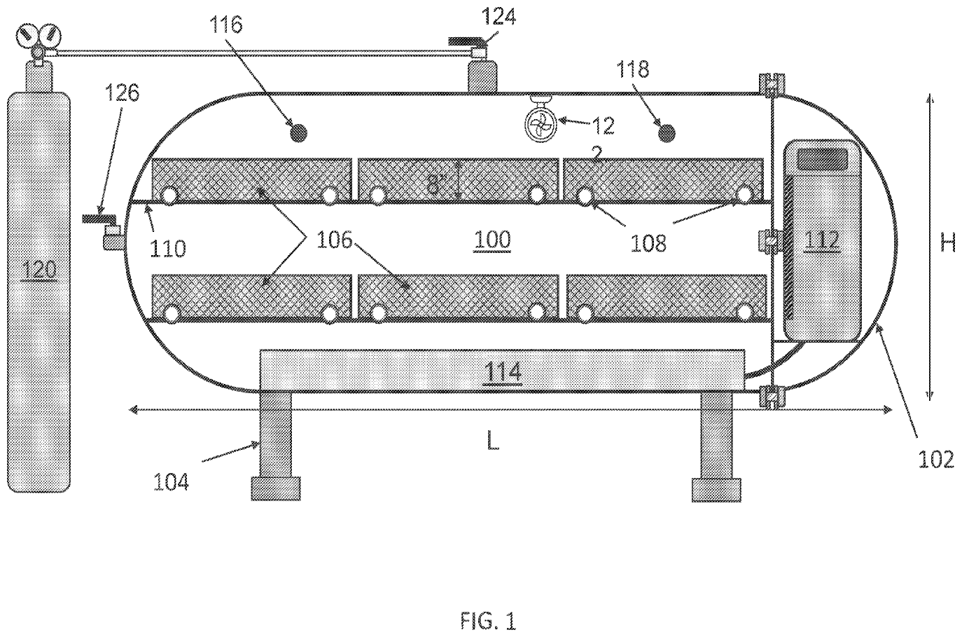

A prototype chamber 100 was fabricated using a 500-gallon (1900-L) propane tank. (See FIG. 1.) The tank was modified to have an out swinging door 102 with six threaded tailgate latches to hold the door 102 shut during treatment. In order to obtain an airtight seal, a flat 2 inch (″)×¼″ (5.0 centimeters (cm)×0.64 cm) steel lip was welded to the body of the tank, with an additional lip and latch support welded to the door. A natural rubber seal was placed on top of the two-inch lip and glued into place, then sealed with a rubber gasket sealant. The base of the tank was widened for additional stability during treatment and to support the additional weight of the new door. A 4-inch×2-inch (10 cm×5 cm) rectangular steel tube was used to fabricate the wider base stand 104. Treatment baskets 106 were fabricated out of expanded metal, steel angle, and flat steel bar. In one or more embodiments, the treatment baskets may be 26 inches long. A total of 6 rolling baskets 106 were fabricated to hold rock during treatment. Wheels 108 were added to the baskets to allow the baskets to be rolled into place on welded rails 110 inside of the treatment chamber 100. In addition to the baskets 106 and general tank modifications, a stand for the dehumidifier 112 was installed in the chamber door 102, and a metal box (a water collection container 114) was fabricated to contain the water that was collected by the dehumidifier 112 during treatment. Carbon dioxide intake ports, sensor ports, a pressure relief valve (or ejection valve), and openings for electrical components were fabricated to complete the chamber 100. After completing the modifications of the new treatment chamber design, the chamber 100 was tested to hold a maximum gauge pressure of 65 psig (450 kPa). (Note that pressures in the present disclosure are gauge pressures unless otherwise indicated.) In later tests, the rubber chamber seal failed at 70 psig (480 kPa).

### Recycled Concrete Aggregate: Origin and Preparation

The material used in the experiments was a mixed blend from an airfield and a highway. The materials were crushed using two crushers (McCloskey J50 Jaw Crusher and McCloskey 144 Impact Crusher) and then screened using McCloskey S190 Screener stations to have the 1-inch (2.5-cm) Nominal Maximum Size of Aggregate (NMSA) RCA samples.

### Mid-Scale Carbon Dioxide Treatment

The fabrication and different parts of the mid-scale prototype chamber 100 were described above. The monitoring and control systems include a dehumidifier 112 (to control the relative humidity of the chamber during the treatment), a pressure transducer sensor 116 (Omega, 0-100 psig, i.e., 0-690 kPa), temperature/relative humidity sensor 118 (Vaisala, HMP110), a carbon dioxide high purity cylinder 120 (99.9% purity grade, Matheson), and a data acquisition system to record the pressure and temperature/RH during the treatment process (Keysight 34972A). While the experiments were conducted with high purity carbon dioxide, lower purity carbon dioxide can also be used, for example, carbon dioxide from an industrial process. The prototype chamber 100 is shown in FIG. 1.

### Mid-Scale Carbon Dioxide Treatment

### Test Procedure

To have a consistent ambient temperature and relative humidity as well as reduce the effect of sharp seasonal and hourly temperature/RH change, the treatment chamber was placed inside a machine shop. The RCA samples were placed inside the machine shop, spread on the floor, and dried using an oscillating fan 24 hours prior to the start of the treatment process. This process may have helped to have consistent water content and temperature of the RCA samples before starting the carbon dioxide treatment, for all treatment implementations. The RCA samples were periodically turned over using shovels to facilitate drying.

Two different loading arrangements (basket and simple loose load) were used to study the effect of loading arrangement of RCA treatment. In this way, in the basket loading arrangement, six rolling baskets 106 were equally loaded by pre-dried RCA samples using shovels, then placed inside the chamber 100 one by one in two layers as shown in FIG. 1. For the simple loose load arrangement approach, a similar sample volume was first measured by loading six baskets and then dumped into the treatment chamber and spread out evenly at the bottom of the chamber 100. In this case, the water collection container 114 was placed at the top of the samples.

After loading the RCA samples inside the treatment chamber 100, the dehumidifier 112 was set to a 40% relative humidity to ensure the chamber's average relative humidity of 50-60% during the carbon dioxide treatment process. The chamber door 102 was then closed tightly, and the carbon dioxide was pressurized inside the chamber 100 up to 1-2 psig (6.9 kPa-13.8 kPa), then the pressure was released from the pressure relief valve 126 in order to sweep out the air inside the chamber 100 and have the pure carbon dioxide during the treatment process. The chamber 100 was then pressurized until the desired carbon dioxide pressure was reached, at which time the carbon dioxide intake valve 124 was closed (i.e., CO₂ set pressure). As a second carbon dioxide supply mode, the intake valve 124 was kept open at a certain level to ensure the continuous supply of carbon dioxide gas to the chamber 100 and to keep the chamber pressure at a constant level (i.e., CO₂ continuous supply). During the treatment, the carbon dioxide pressure, the temperature, and the relative humidity inside the chamber 100 were recorded using the sensors 116, 118 connected to the treatment chamber and the data acquisition system and computer. The carbon dioxide treatment was stopped either after all carbon dioxide gases were consumed (carbon dioxide pressure inside the chamber reaches zero) or after 24 hours in cases where the carbon dioxide pressure had not reached zero after 24 hours of treatment.

### RCA Sampling for Laboratory Mechanical and Environmental Tests

After carbon dioxide treatment was competed, any remaining carbon dioxide pressure was released using the pressure relief valve 126, and the chamber door 102 was opened. For each treatment implementation, three buckets (5-gallon (19-L) capacity) were collected and transferred to the laboratory for further mechanical and environmental tests. Due to the importance of the sampling process and having representative samples, the sampling process was kept similar for all treatment implementations. In this regard, for the basket arrangement method, each sample bucket was filled by two shovels from each basket. For the simple loose loading approach, the buckets were filled by two shovels from the top, middle, and bottom of the RCA pile inside the chamber. In total, thirty-five separate treatment implementation tests were conducted in various conditions, as listed in Table 2. For simplicity, each treatment condition is presented as an abbreviation as follows: SPB10: Initial set pressure, basket, 10% volume; SPB20: Initial set pressure, basket, 20% volume; SPD20: Initial set pressure, simple loose load, 20% volume; CPB20: Continuous pressure, basket, 20% volume.

TABLE 2
Mid-scale CO₂ treatment conditions

| | Sample | RCA | Pressure | Pressure | Duration | Pre-Drying |
|---|---|---|---|---|---|---|
| Chamber | Arrangement | Volume | [psig] | Supply | [hour] | Condition |
| Mid-Scale | Basket | ¹10% | 1, 5, 10, | Initial set | Various | As in the Field |
| | | | 20, 40, 60 | | | |
| | | ²20% | 1, 5, 10, | | | |
| | | | 20, 40, 60 | | | |
| | Simple loose | ³20% | 10, 20, | | | |
| | load | | 40, 60 | | | |
| | Basket | ⁴20% | 10, 20, 40 | Continuous | 1, 2, 4 | As in the Field/ |
| | | | | supply | | 48-hr dried |

Note:
Thereafter the treatment conditions are abbreviated in the context:
¹SPB10,
²SPB20,
³SPD20,
⁴CPB20

### Laboratory-Scale Carbon Dioxide Treatment

### Test Setup

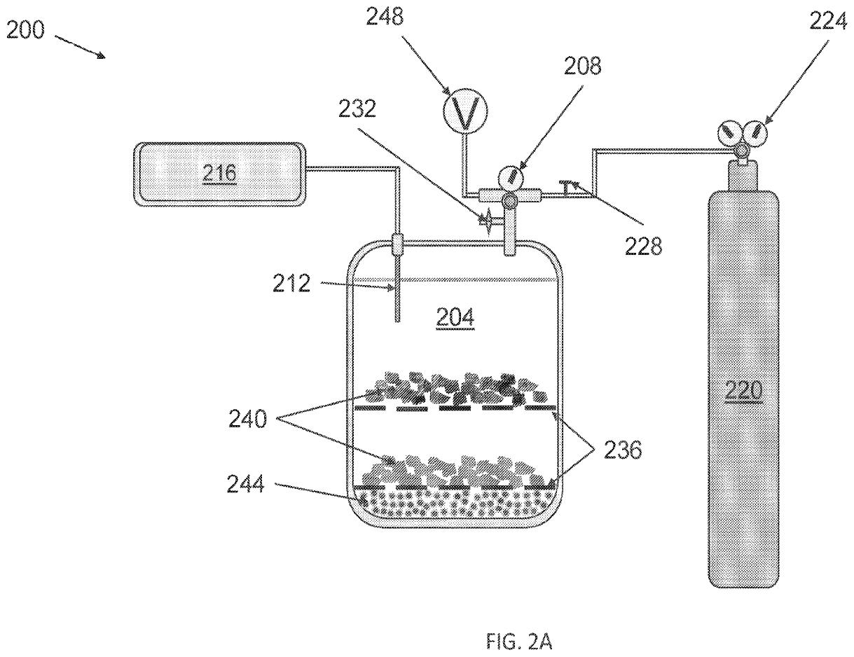

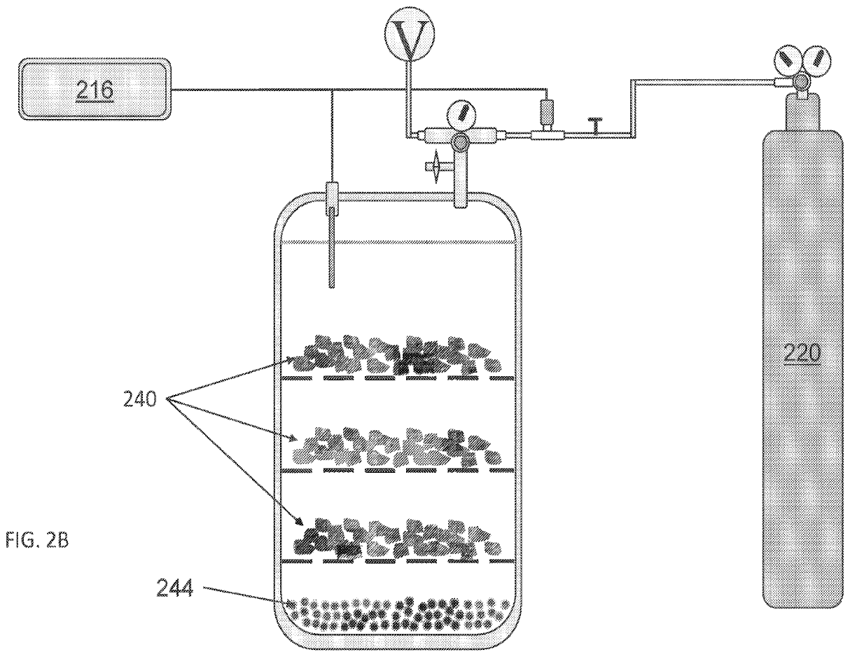

The laboratory treatment setup 200 includes a sealed treatment chamber 204 (either 10-L or 30-L capacity), a pressure transducer 208 (Omega, 0-200 psig (0-1.4 MPa)), and a Temperature/Relative humidity sensor 212 (Vaisala, HMP110) connected to the chamber. The sensors 208, 212 were connected to a data acquisition system 216 (Keysight, 34972A) to record the pressure, temperature, and RH inside the treatment chamber 204 during the treatment process. A high purity (99.9%, Matheson) carbon dioxide cylinder 220 was also connected to the treatment chamber 204 via a pressure regulator 224 to control the rate of carbon dioxide supply into the treatment chamber 204. Each treatment chamber 204 has two valves at the top, one for carbon dioxide intake 228 and another, a safety valve 232, for vacuum/pressure relief purposes, as shown in FIGS. 2A and 2B. The carbon dioxide intake valve 228 can be a needle valve. The chamber includes racks 236 to hold the RCA samples 240 and ensure enough surface contact between RCA and carbon dioxide (for example, two racks in the 10 L chamber and four racks in 30 L chamber).

### Test Procedure

In the laboratory carbon dioxide treatment approach, a specific size of the RCA samples was used to minimize the size effect and better control the carbon dioxide treatment process and analysis. In this regard, the same RCAs from the mid-scale treatment were additionally sieved. The samples that passed through a ½-inch (1.3-cm) sieve but were retained on a ⅜-inch (1.0-cm) sieve were gathered for laboratory carbon dioxide treatment implementations. Sieved RCA samples were initially pre-conditioned to ensure the sample's consistent initial RH and temperature (T) inside a control room (with T=73.4-77° F. (24±1° C.) and RH=50%±1) for 24 hours before starting the treatment process. A certain amount of silica gel 244 (s.g.; Interra Global) was then placed at the bottom of the chamber (or as an extra layer at the middle of the chamber in some cases in the 30 L chamber) to control the RH inside the chamber during the treatment process. Afterward, a certain amount of the pre-conditioned RCA samples (2.6 pounds (1.2 kg) in the 10 L chamber and 11 pounds (5 kg) in the 30 L chamber) was put equally on the racks and then moved to the treatment chamber 204. Then, the chamber cap was closed tightly, and the carbon dioxide injecting tube was also connected to the chamber. In order to have a pure carbon dioxide gas inside the chamber, a low carbon dioxide pressure (2-3 psig (13.8-20.7 kPa)) was applied, followed by the exit of the injected CO₂ via the pressure relief valve 232 (i.e., CO₂-purge). Also, three carbon dioxide injections/vacuum (up to 13 psig (90 kPa)) cycles were applied in the treatments using the 10 L capacity chamber (i.e., CO₂-vacuum). Evacuation was performed using a vacuum pump 248. The carbon dioxide was then injected into the chamber up to a certain pressure level, and the valve was closed.

After 24 hours, the pressure relief valve 232 was opened to release the remaining carbon dioxide gas inside the chamber, and the chamber cap was opened. The treated RCA was collected from the chamber, the weight of the samples was also measured after the treatment process. Six individual RCA samples were randomly selected for phenolphthalein tests at the surface and cross-section of the treated samples. The remaining samples were prepared for the ACV test and water content measurements. Table 3 summarizes the laboratory-scale carbon dioxide-treatment conditions for both treatment chambers.

TABLE 3
Laboratory-scale CO₂ treatment conditions

| Treatment | | RCA mass | | CO₂ pressure | Initial |
|---|---|---|---|---|---|
| Chamber | Pre-condition | [kg] | Silica gel mass [g] | [psig] | pressure |
| 10-liter | W/C | 1.2 kg (2 racks) | 60 (at the bottom) | 1 | CO₂- |
| capacity | | | | 5 | vacuum/ |
| | | | | 10 | CO₂-purge |
| | | | | 20 | |
| | | | | 40 | |
| 30-liter | W/C | 5 kg (4 racks) | 450 (bottom) | 40 | CO₂-purge |
| capacity | | | 600 (bottom) | | |
| | | | 300 (bottom) | | |
| | | | 150 (middle) | | |
| | | | 50 (middle) | | |
| | | | 0 | | |
| | W/O | | 1000 (middle + bottom) | | |
| | W/C (Cold room)* | | 0 | | |
| | W/L | | 150 (middle) | | |
| | N/L | | 150 (middle) | | |

Note:
W/C: washed and placed in the control room at RH = 50% for 24 hours before starting the treatment process, W/O: washed and oven-dried, W/L: washed and laboratory-dried for 48 hours, N/L: no-wash and laboratory-dried for 48 hours.
*This test was conducted in a control room with a constant ambient temperature of 3 ± 0.5° C.

### Physical and Mechanical Tests

To evaluate the physical and mechanical properties of the RCA samples after carbon dioxide treatment, proper standard physical and mechanical tests were conducted on the un-treated (original) and carbon dioxide-treated RCA samples as listed in Table 4. The detailed test procedure related to each laboratory test is described as follows.

TABLE 4
Laboratory mechanical and environmental tests

| Laboratory Tests | Tests Identification | Standard |
|---|---|---|
| Mechanical/Physical | Specific Gravity | ASTM C127 |
| | Absorption Capacity | ASTM C127 |
| | Aggregate Crushing Value (ACV) Index | Modified BS 110-812 |
| | Los Angeles (LA) Abrasion | ASTM C131 |
| | Freeze-Thaw (F-T) Resistance | CSA A23.2-24A |
| Environmental | Laboratory batch leaching | Ohio DOT |

### Specific Gravity and Absorption Capacity

Specific gravity and absorption capacity tests were conducted based on the ASTM C127 standard. Every sample was re-sieved to an identical gradation for higher accuracy (No. 57 per ASTM C33) due to the potential uncertainties of the high variability of RCA samples. Additionally, due to the high absorption capacity of RCA, to ensure the complete saturation of RCA samples, the RCA specimens were soaked for 72 hours instead of soaking for 24 hours (as the standard suggests). The procedure consists of soaking the RCA sample (at least 6.6 pounds (3 kg)) in water, followed by removing the sample from water and rolling it in a large absorbent towel to remove surface water. Then the mass of a saturated-surface-dry (SSD) sample in the air is obtained, followed by measuring the mass of the sample in water to identify the exact volume of the sample. Afterward, the sample is oven-dried at 230±9° F. (110±5° C.) for 24 hours. Then the absorption capacity and specific gravity were calculated using the following equations.

$$Absorption ( \% ) = \frac{B - A}{A} \times 100 \qquad ( 1 )$$

$$Specific gravity ( SSD ) = \frac{B}{B - C} \qquad ( 2 )$$

$$Specific gravity ( OD ) = \frac{A}{B - C} \qquad ( 3 )$$

where A is the mass of oven-dried test sample in air, B is the mass of SSD sample in air, and (is the mass of SSD sample in water.

### Aggregate Crushing Value (ACV)

The ACV test was performed based on the modified BS 110-812 standard. The single-sized RCA sample (½″-⅜″ (1.3 cm-1.0 cm)) is placed inside the 6 inches (154 mm) internal diameter steel ring up to 2 inches (5 cm) in height and tamped 25 times with a ⅝″ (15.9 mm) diameter tamping rod to compact. The load is applied at a 0.35±0.05 inch/minute (in/min), (0.15±0.02 mm/s) rate until the load of 30 thousand pounds-force (kips) (133 kilonewtons (kN)) is reached, followed by an immediate load release. The steel ring with the crushed RCA is placed on a vibrating table and vibrated to loosen the compressed RCA sample. A crushed RCA sample was sieved using a No. 8 sieve. The Aggregate Crushing Value (ACV) was calculated as a percentage of particles that passed the No. 8 sieve and the following equation.

$$ACV ( \% ) = \frac{Mass of material passed No \text{.8}}{Original mass of sample} \times 100 \qquad ( 4 )$$

### Los Angeles (LA) Abrasion

The LA abrasion test was conducted according to the ASTM C131 standard. A specifically graded sample was prepared by combining 5 lb (2.5 kg) of ½-inch (1.3-cm) sized RCA and 5 lb (2.5 kg) of ⅜-inch (1.0-cm) sized RCA. Then the sample is placed in the LA testing machine together with the charge, which consists of 11 steel spheres of 440 gram each. The machine is then rotated at a speed of 30-33 revolutions per minute (rpm) for 500 revolutions. After 500 revolutions are completed, the material is discharged and sieved with a No. 12 sieve. The mass that passed the No. 12 sieve is recorded, and LA abrasion mass loss was calculated using the following equation.

$$LA abrasion mass loss ( \% ) = \frac{Mass of material passed No \text{.12}}{Original mass of sample} \times 100 \qquad ( 5 )$$

### Freeze an Thaw (F-T) Resistance

The freeze-thaw (F-T) resistance of the aggregates was evaluated based on the CSA A23.2-24A standard. Although the standard requires testing of every size fraction, this study focused on ½-inch (1.3-cm) sized RCA only. The first step is careful preparation of the oven-dried sample (2.75 lb (1.25 kg)) by removing any contaminants such as asphalt brick, wood, and metal. Then, the RCA sample is placed in appropriately sized (1 L in this case) containers, followed by filling them with a prepared 3% sodium chloride (NaCl) solution to immerse all aggregate particles. Containers are then sealed and kept at room temperature for 24 hours. Afterward, the solution is removed by inverting a container over a screen smaller than 5 mm mesh. Containers are then sealed and placed in a freezer at 0° F. (−18° C.) for 16 hours, which is a freezing cycle stage. The thawing cycle is started by removing the containers from the freezer and leaving them at room temperature for 8 hours. These cycles are repeated five times. After five cycles of freezing-thawing, aggregates are washed by filling the container with tap water and draining the container by inverting it over a No. 4 mesh for 5 seconds. This step is repeated five times to ensure the RCA particles are thoroughly washed. Then the sample is oven-dried at 110° C. for 24 hours. Finally, the oven-dried RCA sample is sieved using an appropriate sieve (½-inch (1.3-cm), in this case), and mass loss is recorded.

### Environmental Tests

### Laboratory Batch Leaching Test

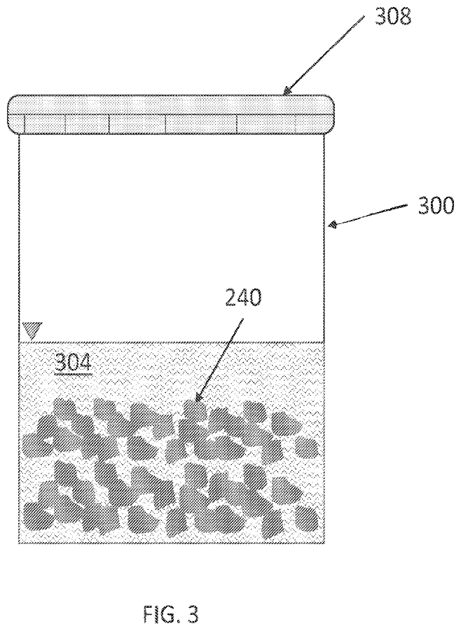

The laboratory batch leaching test was conducted on the un-treated (original) and carbon dioxide-treated samples to evaluate the effect of the carbon dioxide treatment on the environmental aspects of the RCA samples 240. For this purpose, 10 lb. (4.54 kg) RCA sample 240 (1-inch (2.5-cm) screened, similar grading as in the field-scale treatment) were submerged in 1 gallon (3.79 L) of distilled water 304 in a plastic bucket 300 (5-gallon (18.9-L) capacity) with a sealed door 308, as shown in FIG. 3. Then the leachate water sample was collected from the buckets 300 after the time elapse of 1, 2, 4, 7, 14, and 21 days. The pH value and total element concentrations of the leachate water samples were measured using a pH meter (Accumet AB15) and ICP-MS (Inductively Coupled Plasma Mass Spectrometry) devices, respectively. This test procedure was modified from Ohio DOT 2002 report.

Concrete Mix with Carbon Dioxide-Treated RCA

### Concrete Mixing

A drum mixer with 3 cubic feet (ft³, 0.0849 m³) capacity was used to mix concrete following the procedure described in ASTM C192 (Standard Practice for Making and Curing Test Specimens in the Laboratory). First, the coarse aggregate was mixed with approximately half of the mixing water containing AEA (Air-Entraining Agent) for 30 seconds. Then, sand and gravel, cement, and the remaining water were added and mixed for 3 minutes, followed by 3 minutes resting and an additional 2 minutes mixing. If it was necessary to adjust workability, WR (Water Reducer) was added, and concrete was mixed for an additional 3 minutes. In the performance evaluation phase, when WR dosage was already known for a particular mixture, it was added with the second half of the water. Prior to mixing, aggregates were brought to saturated condition, and the water amount was adjusted according to the moisture condition of the aggregates prior to batching of each mix, which was 1.3 ft³ (0.0368 m³) in size.

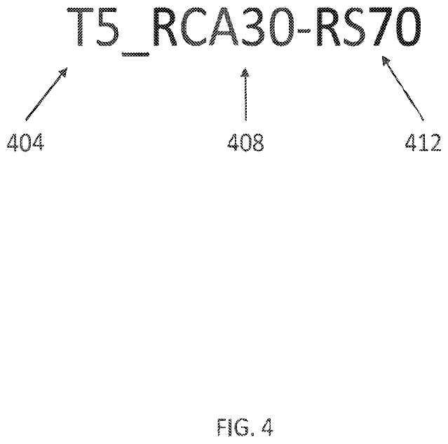

Tables 5 and 6 show the mix design and the mix proportions for mixtures in the study, where pcy is pounds per cubic yard and cwt is hundredweight, or 100 pounds (45 kg). Thus, fluid ounces per 100 pounds is abbreviated fl oz/cwt. The mix identification is based on three parameters, i.e., treatment pressure 404 (T for treated or U for untreated) and the factions of RCA or NA (Natural Aggregates) 408 and river sand (RS) 412. For example, T5_RCA30-RS70 stands for a mixture with an RCA treated at 5 psig (34.5 kPa), and RCA and RS fractions of 30 and 70, respectively (FIG. 4). Noted that as the specific gravities of the RCA before and after carbon dioxide treatment are almost identical, the mixture design for all the RCA mixtures is the same. Due to the lower specific gravity of RCA (compared to NA), a lower amount of coarse aggregate was used in the RCA mixtures.

TABLE 5
Mix design of the concrete prepared with the RCA

| | Type IP | Water | Coarse | Sand and Gravel | AEA | WR |
|---|---|---|---|---|---|---|
| | cement (pcy) | (pcy) | RCA (pcy) | (pcy) | (fl oz/cwt) | (fl oz/cwt) |
| RCA | 564 | 231 | 815 | 2055 | 1.0 | 8.0 |
| NA | 564 | 231 | 900 | 2055 | 1.0 | 8.0 |

TABLE 6
Properties of the concrete prepared with the RCA

| | Type IP | | Coarse | Sand and | AEA | WR |
|---|---|---|---|---|---|---|
| | cement | Water | RCA | Gravel | (fl | (fl |
| | (pcy) | (pcy) | (pcy) | (pcy) | oz/cwt) | oz/cwt) |
| U_NA30-RS70 | 564 | 231 | 900 | 2055 | 1.0 | 8.0 |
| U_RCA30-RS70 | 564 | 231 | 815 | 2055 | 1.0 | 8.0 |
| T5_RCA30-RS70 | 564 | 231 | 815 | 2055 | 1.0 | 8.0 |
| T10_RCA30-RS70 | 564 | 231 | 815 | 2055 | 1.0 | 8.0 |
| T20_RCA30-RS70 | 564 | 231 | 815 | 2055 | 1.0 | 8.0 |
| T40_RCA30-RS70 | 564 | 231 | 815 | 2055 | 1.0 | 8.0 |
| T60_RCA30-RS70 | 564 | 231 | 815 | 2055 | 1.0 | 8.0 |

### Results: Mid-Scale Carbon Dioxide Treatment

Various carbon dioxide treatment conditions were applied to evaluate the effect of each variable on the carbon dioxide-treatment procedure and RCA mechanical and environmental properties and finally find the optimum variable ranges based on the mechanical, environmental, and cost analysis of the results. Table 7 listed the recorded parameters of all thirty-five individual mid-scale carbon dioxide treatment implementations at various conditions.

TABLE 7
CO₂-treatment conditions and recorded data before, during, and after
the CO₂ treatment process for all treatment implementations

| | | | Initial CO₂ | | | Pressure | | | Average | |
|---|---|---|---|---|---|---|---|---|---|---|
| Pre- | RCA | Sample | pressure | Pressure | Duration | Drop | Wt % | Wt % | Temperature | Average |
| Drying | Volume | Holder | (psig) | supply | (hr) | (psi) | Before | After | (° C.) | RH |
| As in | 10% | Basket | 1 | Initially | 1 | 1 | 4.30 | 4.50 | 20.3 | 43.8 |
| the | | | 5 | set | 12 | 5 | 3.90 | 4.10 | 23.3 | 53.0 |
| field | | | 10 | | 20 | 10 | 4.00 | 3.90 | 24.5 | 51.9 |
| | | | 20 | | 24 | 16 | 3.60 | 3.10 | 26.6 | 53.9 |
| | | | 40 | | 24 | 19 | 3.90 | 3.20 | 22.3 | 66.4 |
| | | | 40 (2) | | 24 | 22 | 3.17 | 2.93 | 24.6 | 55.1 |
| | | | 60 | | 24 | 17 | 3.50 | 3.44 | 23.9 | 55.0 |
| | | | 60 (2) | | 24 | 23 | 3.28 | 3.10 | 23.5 | 55.6 |
| | 20% | | 1 | | 1 | 0 | 4.62 | 5.50 | 18.8 | 56.0 |
| | | | 5 | | 7.5 | 5 | 3.80 | 4.39 | 21.5 | 53.5 |
| | | | 10 | | 24 | 9 | 3.90 | 4.66 | 19.0 | 54.0 |
| | | | 10 (2) | | 4.5 | 10 | 3.87 | 3.60 | 25.0 | 53.0 |
| | | | 10 (3) | | 4.5 | 10 | 2.98 | 3.10 | 21.2 | 49.9 |
| | | | 20 | | 24 | 18 | 3.74 | 3.52 | 23.9 | 54.1 |
| | | | 20 (2) | | 9 | 20 | 3.65 | 3.29 | 26.3 | 51.9 |
| | | | 40 | | 24 | 30 | 4.45 | 4.22 | 24.9 | 58.4 |
| | | | 40 (2) | | 24 | 24 | 3.93 | 5.03 | 24.9 | 56.5 |
| | | | 60 | | 24 | 53 | 2.7 | 2.7 | 26.9 | 51.6 |
| | | | 60 (2) | | 24 | 33 | 4.62 | 3.51 | 26.0 | 56.3 |
| As in | 20% | Bakset | 10 | Continuous | 1 | N/A | 5.00 | 4.65 | 24.0 | 57.4 |
| the | | | 10 | Supply | 2 | | 4.97 | 4.70 | 25.2 | 57.3 |
| field | | | 10 | | 4 | | 4.32 | 4.25 | 24.7 | 55.0 |
| | | | 20 | | 1 | | 4.43 | 4.46 | 22.5 | 57.7 |
| | | | 20 | | 2 | | 3.82 | 3.99 | 21.2 | 51.2 |
| | | | 20 | | 4 | | 3.05 | 3.67 | 24.3 | 53.2 |
| | | | 40 | | 1 | | 3.93 | 4.45 | 23.7 | 63.6 |
| | | | 40 | | 2 | | 4.23 | 3.96 | 20.6 | 53.9 |
| | | | 40 | | 4 | | 3.72 | 4.21 | 29.2 | 57.8 |
| 48 hrs | | | 10 | | 2 | N/A | 2.19 | 2.93 | 24.6 | 44.5 |
| drying | | | 20 | | | | 3.30 | 3.15 | 24.5 | 51.9 |
| | | | 40 | | | | 2.64 | 3.53 | 26.0 | 55.5 |
| As | 20% | Simple | 10 | Initially | 5 | 10 | 2.54 | 2.86 | 18.9 | 52.3 |
| in the | | loose | 20 | set | 18 | 20 | 3.41 | 3.44 | 24.8 | 55.5 |
| field | | load | 40 | | 24 | 24 | 4.18 | 3.1 | 23.2 | 55.5 |
| | | | 60 | | 24 | 30 | 3.95 | 4.24 | 23.81 | 56.1 |

### Physical and Mechanical Tests

### Specific Gravity & Absorption

The specific gravity and absorption capacity of the un-treated and carbon dioxide treated RCA samples in all treatment conditions following the ASTM C127 standard are listed in Table 8. Pressure is expressed in units of pounds per square inch gauge (psig). The results indicated that the specific gravity and absorption capacity of RCA samples were not meaningfully changed after carbon dioxide treatment at various treatment conditions.

TABLE 8
Specific gravity and absorption capacity
of untreated and CO₂-treated RCA samples

| Test Condition | | | Pressure | Specific Gravity | Absorption Capacity |
|---|---|---|---|---|---|
| Original | | | | 2.27 | 5.38 |
| Initial | 10% | Volume | 1 | 2.28 | 5.24 |
| Set | | | 5 | 2.29 | 5.02 |
| Pressure | | | 10 | 2.23 | 6.30 |
| (Basket) | | | 20 | 2.29 | 4.92 |
| | | | 40 | 2.30 | 4.87 |
| | | | 60 | 2.27 | 5.46 |
| | 20% | Volume | 1 | N/A | N/A |
| | | | 5 | 2.25 | 5.49 |
| | | | 10 | 2.27 | 5.68 |
| | | | 20 | 2.27 | 5.44 |
| | | | 40 | 2.25 | 5.85 |
| | | | 60 | N/A | N/A |
| Continuous | 1 | hour | 10 | 2.25 | 6.06 |
| CO₂ Supply | | | 20 | 2.23 | 6.42 |
| (Basket) | | | 40 | 2.25 | 6.08 |
| | 2 | hours | 10 | 2.24 | 6.11 |
| | | | 20 | 2.25 | 5.90 |
| | | | 40 | 2.24 | 6.30 |
| | 4 | hours | 10 | 2.26 | 5.96 |
| | | | 20 | 2.25 | 6.11 |
| | | | 40 | 2.27 | 5.88 |
| | 2 | hours | 10 | 2.26 | 5.89 |

| | | | |
|---|---|---|---|
| — | 20 | 2.25 | 6.04 |
| Extra Dry | 40 | 2.25 | 6.04 |

### Aggregate Crushing Value (ACV)

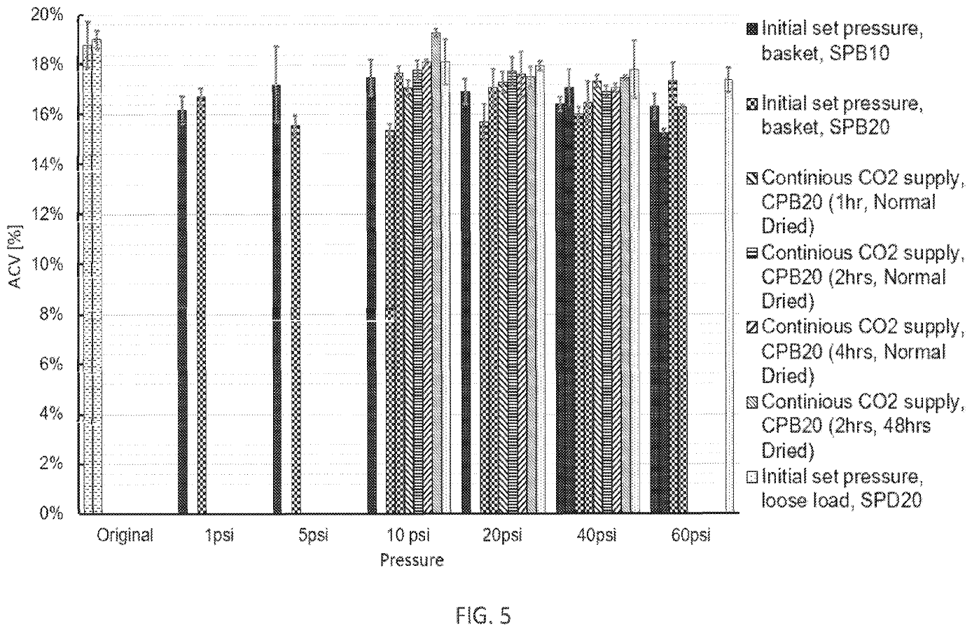

The ACV index of un-treated and carbon dioxide-treated RCA samples in different treatment conditions was measured based on the modified BS 110-812 standard. FIG. 5 combines all measured ACV indexes for all treatment conditions. The results imply that the ACV index is decreased in CO₂-treated RCA samples at all treatment conditions. Among all results, the ACV value for SPB10 and SPB20 shows a relatively lower value, mainly related to the higher contact surface between RCA samples and carbon dioxide in the basket and also longer treatment time.

### LA Abrasion

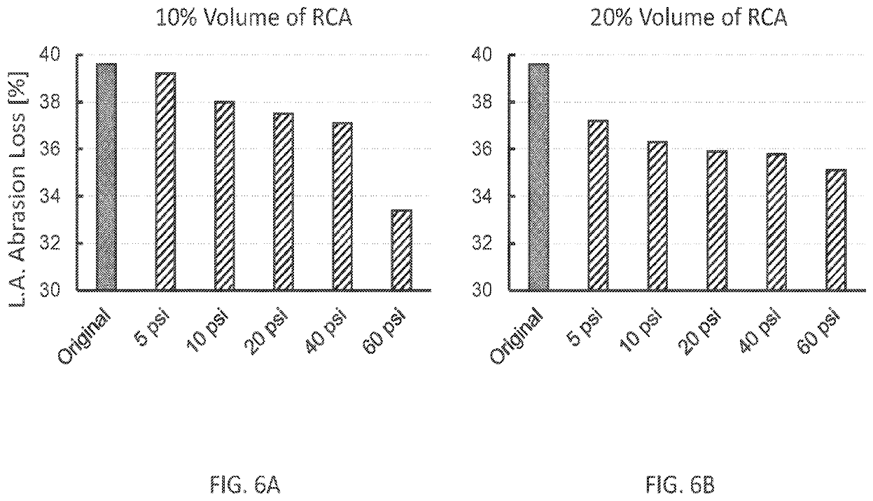

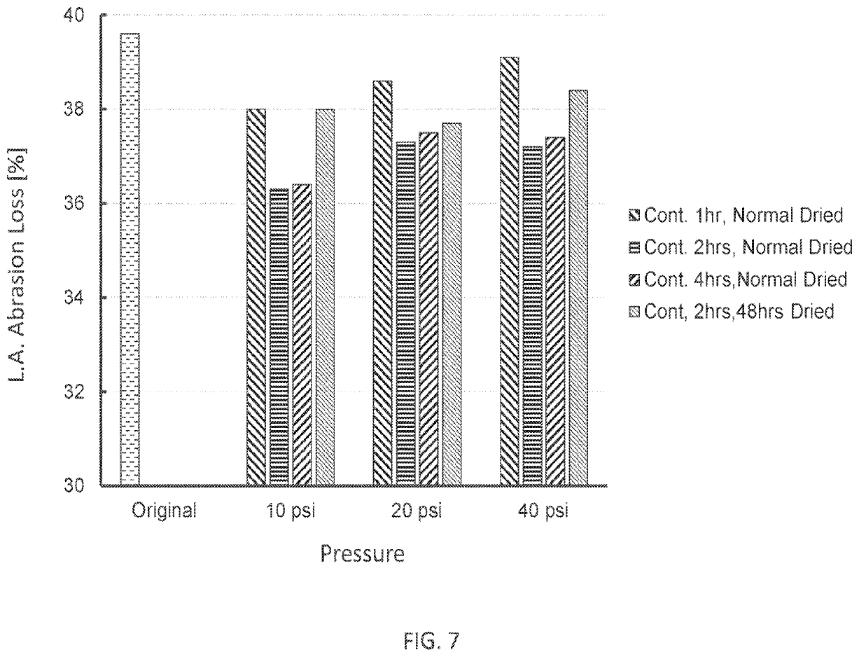

The mass loss of un-treated and carbon dioxide-treated RCA samples after the LA abrasion test was measured using the ASTM C 131 standard. FIGS. 6A, 6B, and 7 show such a mass loss of RCA samples treated for SPB 10 & 20 and CPB20 conditions, respectively. Note that the LA abrasion mass loss of limestone aggregates is about 26.8%. The results clearly indicate the effect of carbonation treatment of RCA on the mass loss decrease.

### Freeze and Thaw (F-T) Resistance

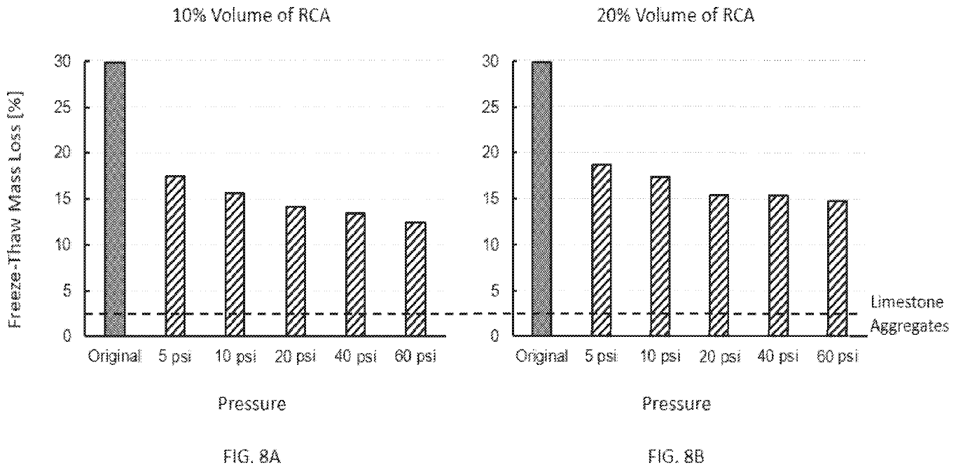

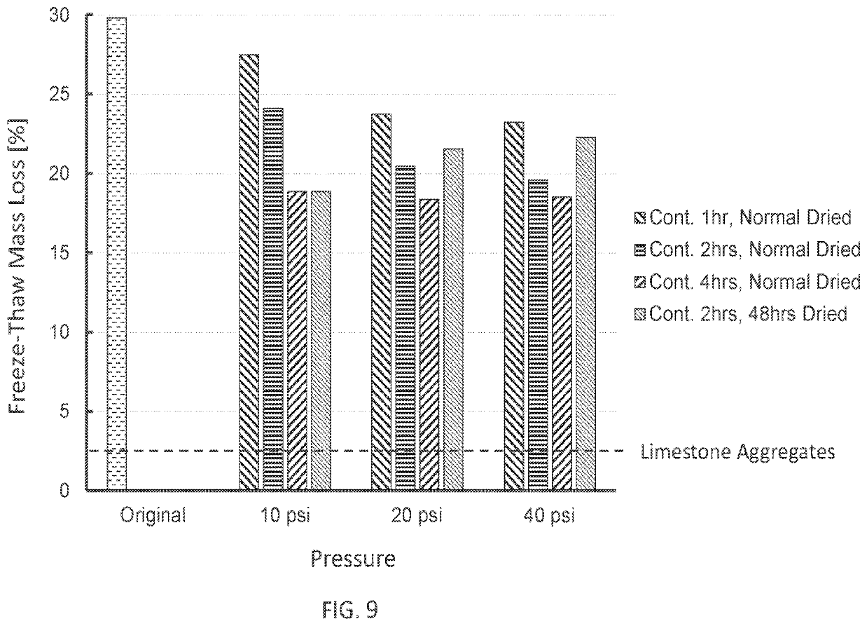

The mass loss of the un-treated and carbon dioxide-treated RCA samples after the freeze-thaw (F-T) resistance test was measured based on the CSA A23.2-24A standard. FIGS. 8A, 8B, and 9 show such a mass loss of RCA samples treated at SPB10 & 20 and CPB20 treatment conditions for various CO₂ pressures, respectively. The dashed line depicts the F-T mass loss of the limestone aggregates (2.63%). The clear trend of mass loss decrease is shown in the result as higher treatment pressure is applied.

### Chemical and Environmental Tests

As the environmental tests, the phenolphthalein pH indicator test, and the batch leaching tests were conducted on the un-treated and carbon dioxide-treated RCA samples. These tests were aimed to evaluate the environmental improvement effect of the CO₂ treatment process on the RCA specimen at various conditions. In the following sections, the phenolphthalein test, leachate pH1, and leachate ion concentrations results are presented, respectively.

### pH of the Carbon Dioxide-Treated RCA (Phenolphthalein Test)

Phenolphthalein test is a quick and easy method to roughly evaluate the acidity or basic condition of the surface and the cross-section of the RCA samples. In this way, six RCA samples were randomly selected, and then the phenolphthalein solution was dropped on the surface of three samples, and the other three samples were broken using a hammer, and the phenolphthalein was dropped on the freshly cut surface to assess the penetration depth of carbon dioxide-treatment.

### Leachate Water: pH

Six RCA leachate water samples were collected after the time elapse of 1, 2, 4, 7, 14, and 21 days for each treatment condition. The water samples were all alkaline (basic) and showed a trend of increasing pH with time, though the original (untreated) samples had the highest pH for a given time and treatment pressure. Based on the EPA National Secondary Drinking Water Regulations (NSDWRs) the standard pH value for drinking water is between 6.5 and 8.5.

### Leachate Water: Heavy Metals

The total element concentration of the RCA leachate water samples from day 1 to day 21 was measured using ICP-MS analytical technique. The concentrations of heavy metals in the leachate water from the un-treated and carbon dioxide-treated samples at various conditions from day 1 to day 21 were all well below the EPA Maximum Contaminant Level (MCL) for drinking water.

Performance of the Concrete with CO₂-Treated RCA

### Fresh Concrete Tests

### (1) Slump Test

A concrete slump was measured according to ASTM C143 (Standard Test Method for Slump of Hydraulic-Cement Concrete) to measure the consistency of concrete. The test was performed immediately after the concrete mixing was completed.

### (2) Air Content Test

Air content of the mixtures was measured and determined according to ASTM C138 (Standard Test Method for Density (Unit Weight), Yield, and Air Content (Gravimetric) of Concrete).

Table 9 summarized the fresh concrete properties of the different concrete mixtures. Results revealed that, regardless of the use of natural aggregate or treated/untreated RCA, all mixtures exhibit comparable properties. Mixtures also exhibit reasonable workability and air content that meets Nebraska Department of Transportation specifications. Unit weight is expressed in Table 9 as pounds per cubic foot (pcf).

TABLE 9
Fresh concrete test results

| Mix ID | Slump (in) | Unit weight (pcf) | Air content (%)* |
|---|---|---|---|
| U_NA30-RS70 | 5.00 | 139.2 | 7.5 |
| U_RCA30-RS70 | 4.00 | 136.6 | 6.8 |
| T5_RCA30-RS70 | 5.00 | 136.8 | 6.6 |
| T10_RCA30-RS70 | 5.00 | 136.5 | 7.1 |
| T20_RCA30-RS70 | 3.00 | 138.0 | 6.2 |
| T40_RCA30-RS70 | 4.50 | 138.2 | 6.1 |
| T60_RCA30-RS70 | 5.50 | 134.0 | 8.7 |

*Gravimetric air content

### Hardened Concrete Tests

### 1) Compressive Strength

Three 4-inch by 8-inch (10 cm×20 cm) cylinders per each mixture were tested for compressive strength based on ASTM C39 (Standard Test Method for Compressive Strength of Cylindrical Concrete Specimens) at 28 days age. All specimens were mechanically end-ground before each test. A compressive machine with a capacity of 400 kips (1,779 kN) was used.

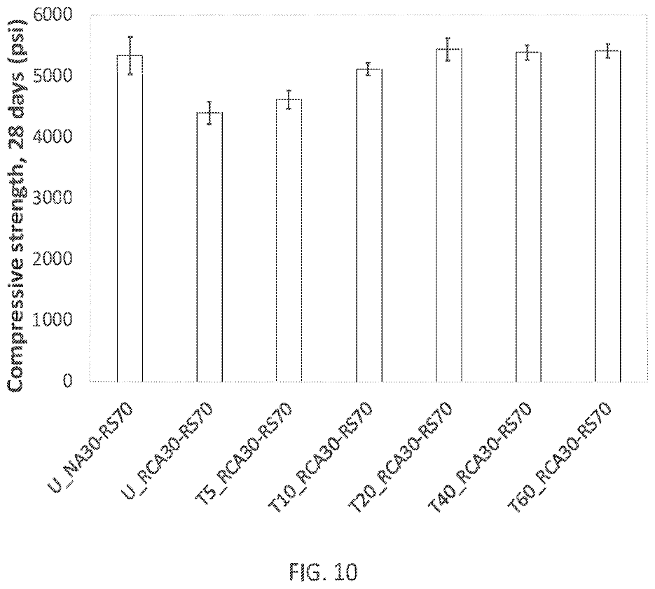

FIG. 10 demonstrates the compressive strength of different mixtures. Results showed that all mixtures had a minimum compressive strength of 3500 psi (24 MPa) at 28 days for pavement concrete application. The use of RCA results in a slight reduction of the compressive strength. However, a clear trend of the increase of compressive strength with the increase of the CO₂ treatment pressure was observed, with the 20 psig, 40 psig, and 60 psig (138 kPa, 276 kPa, and 414 kPa, respectively) treatment pressures used in the present study resulting in compressive strength that is comparable to the reference mixture with natural aggregate.

### 2) Flexural Strength (Modulus of Rupture)

One 6-inch by 6-inch by 20-inch (15-cm×15-cm×51-cm) beam per mixture was tested for modulus of rupture at the age of 28 days according to ASTM C78 (Standard Test Method for Flexural Strength of Concrete (Using Simple Beam with Third-Point Loading)). A flexural testing machine with a capacity of 30 kips (133 kN) was used.

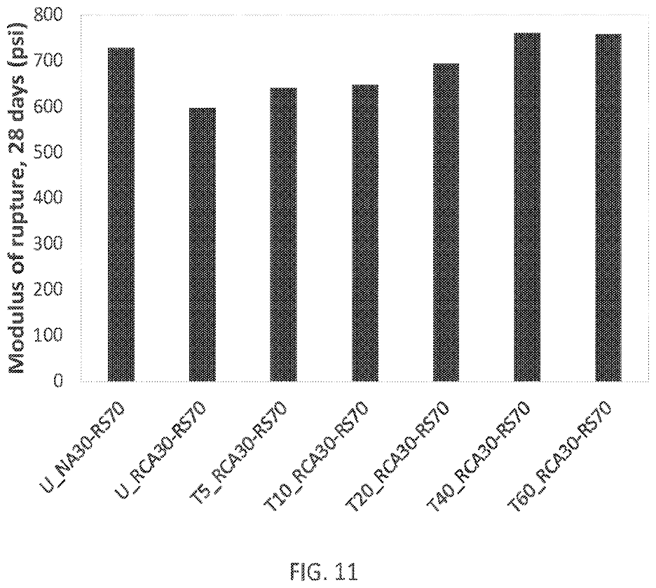

FIG. 11 demonstrates the flexural strength (modulus of rupture) of different mixtures. Results showed that all mixtures except the mixture with untreated RCA have a minimum modulus of rupture of 600 psi (4 MPa) at 28 days for pavement concrete application. Similar to results from the compressive strength test, the use of RCA results in a slight reduction of the compressive strength. However, a clear trend of the increase of flexural strength with the increase of the CO₂ treatment pressure was observed, with the 40 psig (276 kPa) and 60 psig (414 kPa) treatment pressures used in the present study resulting in flexural strength that is comparable to the reference mixture with natural aggregate.

3) Static modulus of elasticity and Possion's ratio test

Modulus of elasticity test was performed at 28 days age according to ASTM C469 (Standard Test Method for Static Modulus of Elasticity and Poisson's Ratio of Concrete in Compression). A frame with two dial gauges to monitor both axial and radial deformations was used. Each test was recorded and later used to build a graph, from which according properties were calculated.

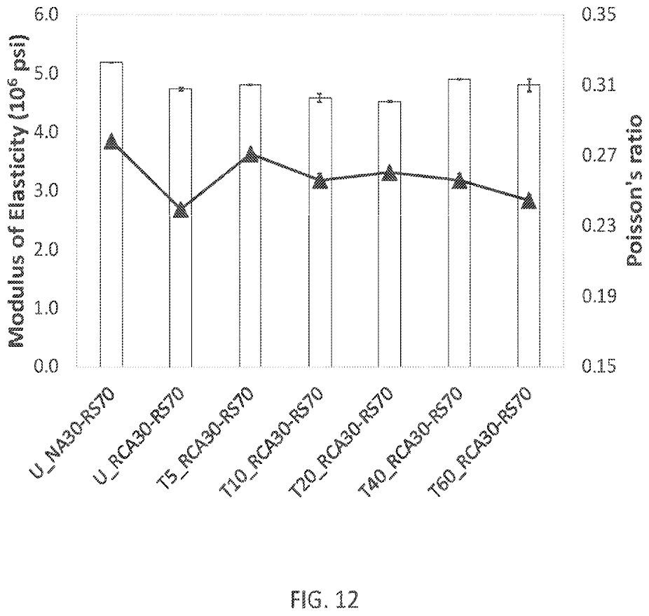

FIG. 12 demonstrates the modulus of elasticity and Poisson's ratio of different mixtures. Results showed that the use of RCA results in a slight reduction of the modulus of elasticity and Poisson's ratio. It is worth noting that the property does not have any major impact on the design of concrete. Unlike compressive strength and flexural strength, no clear trend of the impact of CO₂ treatment was observed.

### 4) Surface and Bulk Resistivity

One 4-inch by 8-inch (10 cm×20 cm) cylinder specimen was randomly selected from each mixture to be tested for the surface and bulk resistivity using a Proceq Resipod testing device at 28-day based on AASHTO TP95 (Standard Method of Test for Surface Resistivity Indication of Concrete's Ability to Resist Chloride Ion Penetration). The Resipod works based on the Wenner probe principles and measures the electrical resistivity of concrete. The specimen were in a fully saturated condition prior to testing. Electric current is applied through the outer probes, while the inner probes measure the voltage.

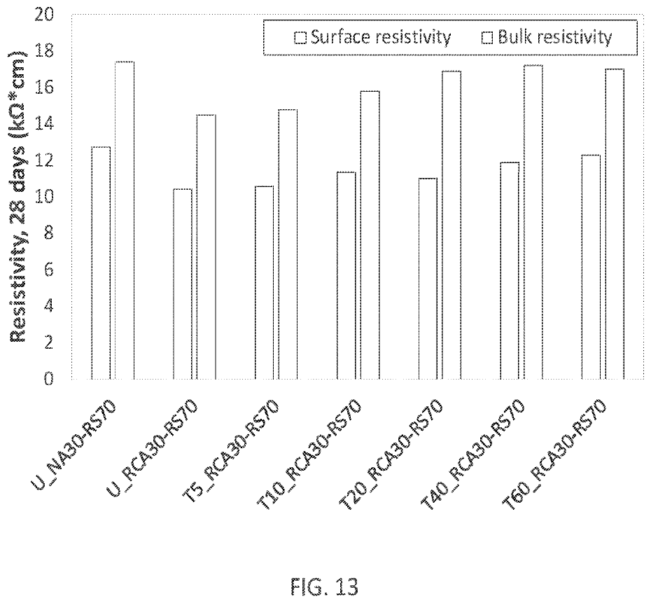

FIG. 13 demonstrates the surface and bulk resistivity of all mixtures. The use of RCA results in a slight reduction of the surface and bulk resistivity, with the untreated RCA mixture exhibiting the lowest resistivity. However, a clear trend of the increase of surface and bulk resistivity with the increase of the CO₂ treatment pressure was observed, with the 20 psig, 40 psig, and 60 psig (138 kPa, 276 kPa, and 414 kPa, respectively) treatment pressures used in the present study resulted in surface and bulk resistivity that is comparable to the reference mixture with natural aggregate.

### ANALYSIS AND DISCUSSION

A detailed analysis based on the experimental data during the carbon dioxide treatment process and ensuing mechanical and environmentally related laboratory tests on the carbon dioxide-treated samples are presented here. In the following sections, the treatment and laboratory results were analyzed based on the carbon dioxide mass consumption calculations, running statistical analysis, cost analysis, and carbon dioxide footprint.

### Carbon Dioxide Mass Consumption

Carbon dioxide pressure decline data individually may not be a comprehensive indicator of carbon dioxide gas consumption. The temperature and RCA volume may be key factors that should be taken into account when gas consumption is considered. Therefore, the carbon dioxide mass consumption was calculated to evaluate the amount and rate of carbon dioxide gas consumption during the treatment process at different treatment conditions and then normalized by the initial RCA mass in each treatment condition. Carbon dioxide mass consumption may be one of the main indicators to quantify the intensity and magnitude of the carbon dioxide treatment process. In this regard, the density of carbon dioxide at the beginning of the test was calculated using a Peng and Robinson Equation of State based on the initial carbon dioxide pressure and temperature inside the treatment (Equations 6-12). Then, the initial mass of carbon dioxide in the chamber was calculated by multiplying the carbon dioxide density with its volume, for which the initial CO₂ volume was obtained using the internal chamber volume and RCA volume. Likewise, the mass of the carbon dioxide at any time after starting the treatment process was also calculated using the same procedure. The carbon dioxide mass difference between the initial (t_0) and the times after starting the test (t_1 to t_n) may represent the carbon dioxide mass consumption during RCA treatment. The initial volume of the RCA samples in the chamber may not be the same in all mid-scale as well as the laboratory-scale treatment tests. Therefore, the amount of carbon dioxide gas consumption is normalized by the initial mass of the RCA in the chamber. In this way, the amount and rate of carbon dioxide gas consumption in all treatment conditions can be easily compared. In this section, the carbon dioxide consumption graphs related to various mid- and laboratory-scale treatment conditions are presented.

$$α ( T ) = exp [ m ( 1 - {T}_{r} ) + {n ( 1 - \sqrt{{T}_{r}} )}^{2} ] \qquad ( 6 )$$

$$a = α ( 0.45724 \frac{{R}^{2} {T}_{crit}^{2}}{{p}_{crit}} ) \qquad ( 7 )$$

$$b = 0.0778 \frac{R {T}_{crit}}{{p}_{crit}} \qquad ( 8 )$$

$$A = \frac{aP}{{R}^{2} {T}^{2}} \qquad ( 9 )$$

$$B = \frac{bP}{RT} \qquad ( 10 )$$

$${Z}^{3} - ( 1 - B ) {Z}^{2} + ( A - 3 {B}^{2} - 2 B ) Z - ( AB - {B}^{2} - {B}^{3} ) = 0 \qquad ( 11 )$$

$$ρ = \frac{P \cdot M}{Z \cdot R \cdot T} \qquad ( 12 )$$

where P is the chamber pressure [Pa], R is the universal gas constant=8.3145 [J·mol⁻¹·k⁻¹], T is the chamber temperature [K], Tᵣ is the relative temperature (=T/T_{crit}), α is the attraction parameter, and Z is the compressibility factor [-]. For the pure carbon dioxide gas, p_{cat}=73.8 [bar], T_{crit}=304.2 [K], m=0.6877, n=0.3813, ρ is CO₂ density [kg/m³], and M is the CO₂ molar mass=0.04401 [kg/mol].

### Mid-Scale Carbon Dioxide Treatment

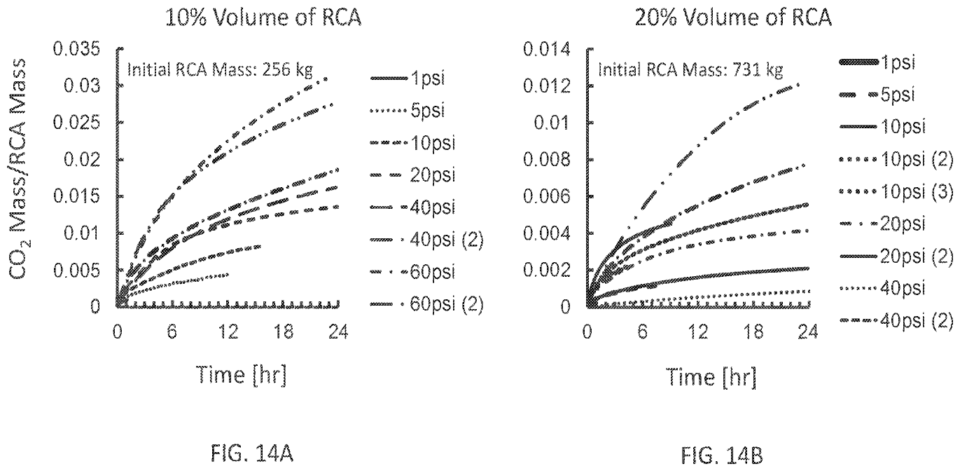

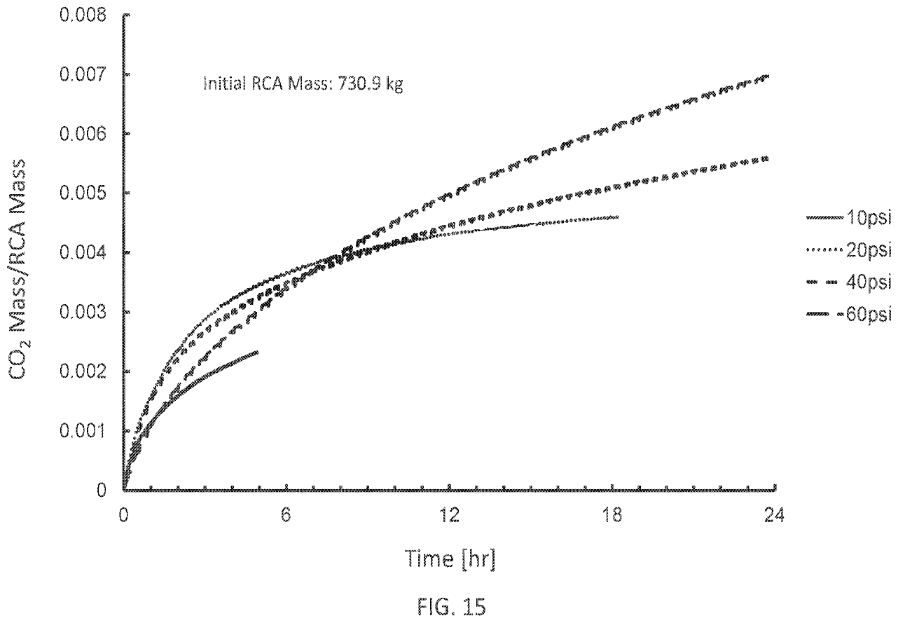

Various treatment conditions were applied using the prototype to evaluate the effect of each parameter on the physical/mechanical properties and the carbon dioxide consumption potential of the RCA samples. FIGS. 14A, 14B, and 15 show the normalized carbon dioxide gas consumption at SPB10, SPB20, and SPD20 treatment conditions, respectively. The exact amount of carbon dioxide mass consumption for the treatment condition with continuous carbon dioxide pressure supply (CPB20) cannot be calculated precisely due to the continuous supply of the carbon dioxide to the chamber. However, based on the calculated results for the SPB conditions, the carbon dioxide consumption was roughly estimated for the CPB20 condition.

The carbon dioxide mass consumption results for different treatment conditions show a larger amount of gas consumption in the order of SPB10, SPB20, and SPD20. It may be interpreted that the initial volume of the carbon dioxide in the chamber and the contact area between the RCA samples and the carbon dioxide plays an important role in the amount of gas consumption during the treatment process. In the condition with a lower volume of RCA and higher amount of carbon dioxide gas, SPB10, carbon dioxide can be more easily absorbed to RCAs, and so, faster carbonation can occur (FIGS. 14A and 14B). On the other hand, aside from the carbon dioxide/RCA volume, the arrangement of the RCA samples in the chamber may play an important role during the carbon dioxide treatment process and carbon dioxide mass consumption. The amount of gas consumption is lower at the condition with the simple loose load arrangement (FIG. 15), perhaps due to the limited contact area between the RCA samples and carbon dioxide in the chamber.

Since the carbon dioxide/RCA volume ratio for conditions SPB20 and CPB20 are similar, the amount of carbon dioxide consumption at CPB20 was roughly calculated based on the SPB20 data, as shown in Table 10.

TABLE 10
CO₂ gas consumption estimation for CPB20 treatment
condition based on the calculated mass consumption
for SPB20 treatment condition

| | CO₂ Mass Consumption - Estimate [kg] | | |
|---|---|---|---|
| Pressure [psig] | 1 hour | 2 hours | 4 hours |
| 10 | 0.442 | 0.884 | 1.768 |
| 20 | 0.902 | 1.804 | 3.608 |
| 40 | 1.476 | 2.952 | 5.904 |

### Laboratory-Scale Carbon Dioxide Treatment

Carbon dioxide mass consumption for various treatment conditions using both sizes of chambers was also evaluated using Peng & Robinson equation of state (EOS).

### 10 L Capacity Chamber

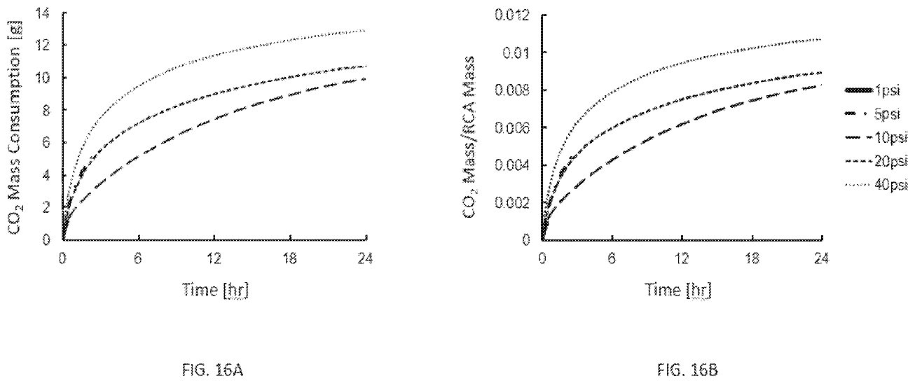

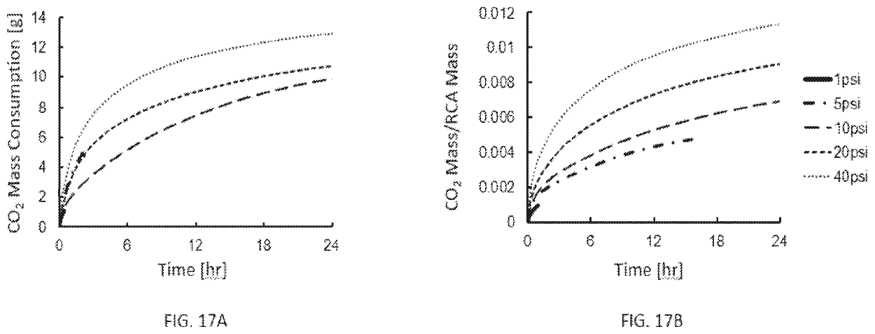

The carbon dioxide mass consumption for the smaller laboratory-scale chamber was calculated using similar calculations. The initialization method was the only variable examined using the smaller chamber. FIGS. 16A, 16B, 17A, and 17B show the carbon dioxide mass consumption during the carbon dioxide treatment of RCA for different initial set pressures with the initial CO₂-vacuum and CO₂-purge, respectively. FIGS. 16A and 16B show carbon dioxide mass consumption and normalized by RCA mass for all treatment pressures using the CO₂-vacuum initialization method. FIGS. 17A and 17B show the carbon dioxide mass consumption and normalized by RCA mass for all treatment pressures using the CO₂-purge initialization method.

The carbon dioxide consumption results are relatively similar for both CO₂-vacuum and CO₂-purge initialization approaches. Therefore, the CO₂-purge method was selected as the initialization approach of the treatment chamber for the 30 L capacity chamber.

### 30 L Capacity Chamber

Various treatment conditions were evaluated using the 30 L capacity chamber in the laboratory scale (see Table 3). The carbon dioxide mass consumption graphs for each treatment variable are presented here to easily assess the effectiveness of each treatment condition on the carbon dioxide mass consumption.

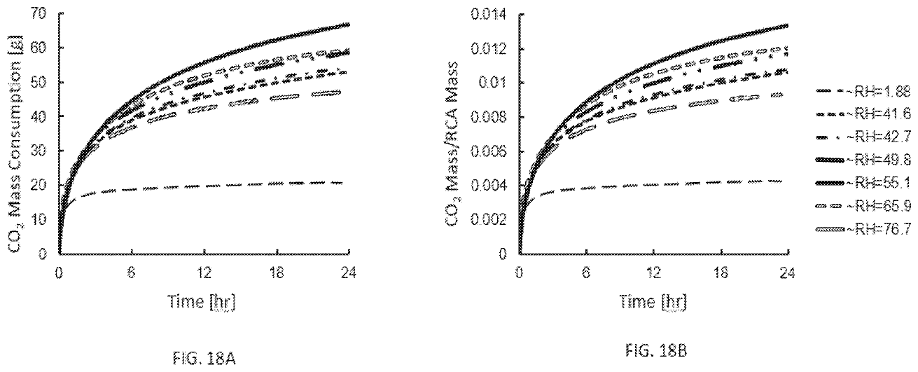

FIGS. 18A and 18B show carbon dioxide mass consumption and normalized by RCA mass for all treatment conditions with different average RH during the treatment. The solid lines show an increase in the carbon dioxide mass consumption by increasing the RH from 1.88% up to 55.1%, then the outlined long dash lines show the drop in carbon dioxide mass consumption by increasing the RH higher than 55.1% up to the maximum value of 76.7%. The chamber does not allow one to increase the average RH higher than 76.7% at the normal laboratory temperature, and this is the maximum RH that was achieved.

The results may indicate that the maximum carbon dioxide consumption may be achieved at the relative humidity of 5015° C. These results confirm the optimal RH range for the carbonation treatment of RCA using carbon dioxide.

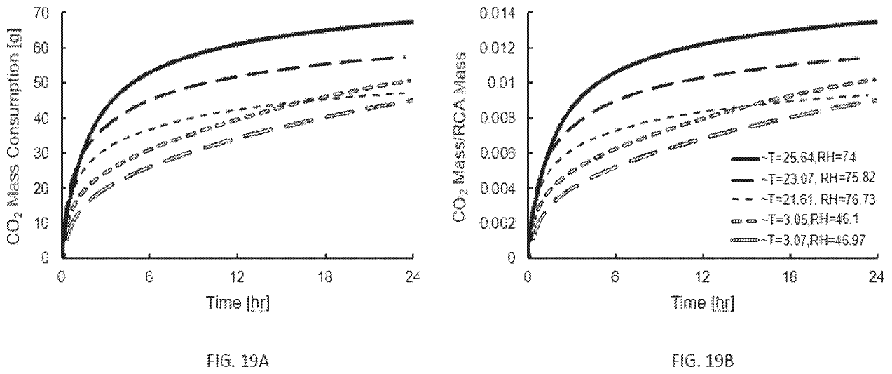

FIGS. 19A and 19B show carbon dioxide mass consumption and normalized by RCA mass for similar treatment conditions (that is, no silica gel and initial set pressure is 40 psig (276 kPa)) at different treatment temperatures. The solid lines show the carbon dioxide mass consumption at general laboratory temperature (21° C.-25° C.), and the outlined dash and outlined long dash lines represent the carbon dioxide mass consumption at colder temperature of −3° C.

Temperature may be another key factor that affects the chemical reactions and thus the carbonation process. Chemical reactions become faster as the ambient temperature is elevated in general geochemistry. The results may indicate that the carbonation process and carbon dioxide consumption may be limited in the lower temperatures (for example, 3° C.).

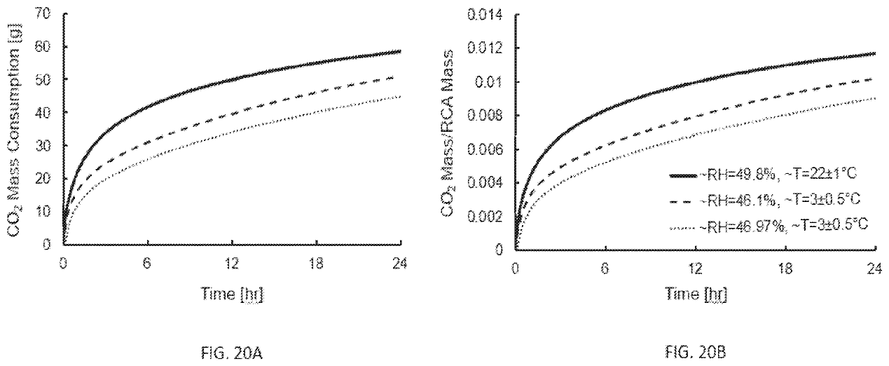

Despite similar test conditions (that is, no silica gel) for all treatment implementations presented in FIGS. 19A and 19B, but due to the different dew points at different temperatures, the average RH is different during the treatments inside the control room (with 310.5° C.). In FIGS. 20A and 20B, the solid continuous line shows the carbon dioxide mass consumption for the treatments at the laboratory temperature and using 150 g S.G. at the middle layer, and the dotted and dashed lines represent the carbon dioxide mass consumption for the treatments in the control room at the constant temperature of 310.5° C. and no silica gel (No S.G.). Therefore, the results of carbon dioxide consumption of the treatment with a similar average RH are presented in FIGS. 20A and 20B. This comparison supports that it is still valid the rate of carbon dioxide consumption; thus the carbonation treatment of RCA is slower in the colder temperature.

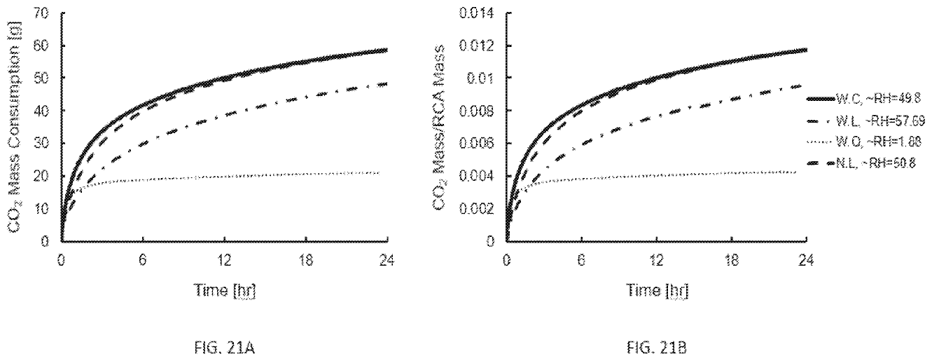

The carbon dioxide consumption of the treatments with different sample pre-conditioning is presented in FIGS. 21A and 21B (W: wash, and N: no-wash of RCAs. C: RCAs are placed in the control room with RH=50±2% & T=22±1° C. for 24 hours before the treatment, L: RCAs are placed in the laboratory with RH=5812% and T=22±1° C., O: RCAs are oven-dried at 105° C. for 24 hours before the treatment). The lowest carbon dioxide consumption was obtained with the oven-dried RCA samples. As it is known that the carbonation reaction needs the presence of moisture in which CO₂ can dissolve, the carbonation of RCA, thus carbon dioxide consumption is limited when RCA are oven-dried. Comparing the conditions with washing and drying in the control room (W.C) and in the lab (W.L) shows the lower carbon dioxide consumption for the W.L condition, which may be due to the higher initial water content and average RH. The results of wash and dry in the control room (W.C) and no wash and dry in the lab (N.L) show similar carbon dioxide consumption, perhaps due to the similar average RH during the treatment and cleaned samples. Therefore, washing does not seem to affect the carbon dioxide penetration and consumption rate.

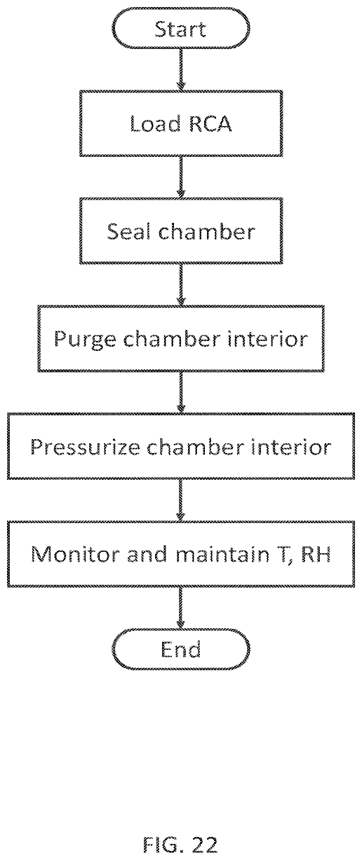

Referring to FIG. 22, one or more embodiments of the present disclosure may provide a method of treating recycled concrete aggregates (RCA). The method may include: loading the RCA into a chamber configured to form a hermetic seal; hermetically sealing the chamber; purging an interior of the chamber of non-carbon dioxide gases; pressurizing the interior of the chamber with carbon dioxide gas; and monitoring and maintaining a temperature and a relative humidity in the interior of the chamber until a predetermined condition is met.

In one or more embodiments, the method may further include at least one member of a group consisting of washing the RCA by immersing the RCA in water at least one time before loading the RCA; drying the RCA before loading the RCA, and stabilizing the temperature of the RCA before loading the RCA. The drying of the RCA may include blowing air over the RCA.

In one or more embodiments, purging may include performing one or more times pressurizing the chamber with carbon dioxide (at low pressure of 2-3 psig (13.8-20.7 kPa) followed by releasing the pressure by opening an escape valve to an exterior of the vessel, or evacuating the chamber. Pressurizing may include injecting an initial volume of carbon dioxide gas sufficient to raise the pressure of the interior of the chamber to a predetermined level. Further, additional carbon dioxide gas may be injected into the chamber to maintain the pressure of the interior of the chamber at the predetermined level. In one or more embodiments, the carbon dioxide gas may be at least 99% pure.

In one or more embodiments, the predetermined condition may be a treatment time or a pressure of the interior of the chamber.

In one or more embodiments, the pressure of the interior of the chamber may be maintained at a gauge pressure between 20 and 60 psig (138 and 414 kPa), the treatment time may be between 4 and 12 hours, loading RCA may include filling 10% to 20% of the volume of the chamber with RCA, the relative humidity within the chamber may be maintained between 40% and 60%, and the temperature within the chamber may be maintained between 20° C. and 30° C.

In one or more embodiments, treated recycled concrete aggregates (RCA) that may have been treated according to the method of all or part of the above methods.

One or more of the above methods may be performed using a chamber as disclosed herein.

One or more embodiments of the present invention may provide a method of optimizing the carbonation of recycled concrete aggregates (RCA). The method may include: performing a plurality of experiments on carbonation of the RCA while changing input parameters between successive experiments. Changing input parameters may include: varying sample pre-conditioning, before placing the RCA in a carbonation chamber, to either include or exclude washing and drying the RCA; varying a volume of the carbonation chamber between 10 L and 2×10⁴ L; varying a percentage of the volume of the carbonation chamber occupied by the RCA between 1% and 50%; varying a temperature of the carbonation chamber between 0° C. and 80° C.; varying a relative humidity of the carbonation chamber between 10% and 75%; varying a gauge pressure of carbon dioxide gas in the carbonation chamber between 1 psig and 100 psig (6.9 kPa and 690 kPa); varying initial carbon dioxide pressurization or continuous carbon dioxide pressurization; varying purging the carbonation chamber by applying vacuum or by at least one cycle of pressurization with carbon dioxide gas followed by depressurization; varying a distribution of the RCA in the carbonation chamber including a simple loose load and in a plurality of baskets; varying duration of carbonation between 1 hour and 72 hours; monitoring a plurality of parameters as a function of time during each experiment on treating RCA, the parameters comprising at least one member of a group consisting of the temperature of the carbonation chamber, the relative humidity of the carbonation chamber, the gauge pressure of carbon dioxide gas in the carbonation chamber; ratio of carbon dioxide mass to RCA mass; and carbon dioxide mass consumption.

The method may further include performing, after carbonation treatment, a plurality of experiments and measurements (on the RCA). These experiments and measurements may include: specific gravity; absorption capacity; aggregate crushing value; Los Angeles abrasion; freeze-thaw resistance; phenolphthalein test; and laboratory batch leaching test. The laboratory batch leaching tests may include measurements of pH and the concentration of heavy metals, comprising at least one member of a group consisting of Pb-208, Se-78; Cd-112; Cr-52; and As-75.

The method may further include measuring properties of a plurality of concretes comprising a plurality of carbonated RCA blends. The properties may include compressive strength, modulus of rupture, modulus of elasticity, surface resistivity, and bulk resistivity.

The method may further include acquiring data before, during, and/or after each carbonation treatment; analyzing the acquired data using at least one member of a group consisting of univariate regression, multivariate regression, principal component analysis, and singular value decomposition; and determining optimal ranges and/or optimal values of a plurality of the input parameters for carbonating RCA for at least one property of RCA after carbonation.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Treated recycled concrete aggregates (RCA), comprising:
waste concrete that has been collected, crushed, and screened to create the RCA, the RCA being hardened concrete comprising natural aggregates bound together by cement paste, wherein the cement paste comprises calcium hydroxide and calcium silicate hydrate;
the RCA loaded into and hermetically sealed within a chamber;
the RCA treated by exposure to carbon dioxide gas within the chamber, the chamber being pressurized with the carbon dioxide gas;
a pressure, a temperature and a relative humidity of the atmosphere inside the chamber during treatment of the RCA having been monitored and controlled until certain predetermined conditions are met;
the predetermined conditions comprising:
a) a treatment time less than approximately 12 hours, wherein the treatment time comprises exposure to pressurized carbon dioxide gas;
b) a pressure greater than 50 psig;
c) a temperature between approximately 0° C. and 80° C.; and
d) a relative humidity between approximately 10% and 75%;
wherein mechanical and chemical properties of the RCA are improved through the treatment.

2. The treated recycled concrete aggregates (RCA) of claim 1, wherein the predetermined conditions comprise:
the treatment time is between approximately 2 hours and 6 hours;
the pressure within the chamber is greater than 60 psig;
the temperature within the chamber is between approximately 20° C. and 30° C.; and
the relative humidity within the chamber is between approximately 40% and 60%.

3. The treated recycled concrete aggregates (RCA) of claim 1, wherein the improved mechanical properties comprise at least one of:
an improvement in aggregate crushing value of at least approximately 10% as compared to untreated RCA;
an improvement in Los Angeles abrasion mass loss of at least approximately 10% as compared to untreated RCA; or
an improvement in freeze-thaw mass loss of at least approximately 20% as compared to untreated RCA.

4. The treated recycled concrete aggregates (RCA) of claim 1, wherein the improved chemical properties comprise at least one of:
a decrease in pH of leachate water of at least approximately one pH unit as compared to untreated RCA; or
a decrease in concentration of heavy metals in leachate water of at least approximately 50% as compared to untreated RCA.

5. The treated recycled concrete aggregates (RCA) of claim 1, wherein concrete mixed with the treated RCA meets at least one of the following requirements:
a minimum compressive strength comparable to concrete mixed with natural aggregates;
a minimum modulus of rupture comparable to concrete mixed with natural aggregates;
freeze-thaw resistance comparable to concrete mixed with natural aggregates;
surface resistivity comparable to concrete mixed with natural aggregates; or
bulk resistivity comparable to concrete mixed with natural aggregates.

6. The treated recycled concrete aggregates (RCA) of claim 5, wherein the treated RCA replaces at least 10% of natural aggregates in the concrete mixed with the treated RCA.

7. The treated recycled concrete aggregates (RCA) of claim 1, wherein the treated RCA is used in asphalt cement concrete (ACC).

8. The treated recycled concrete aggregates (RCA) of claim 1, wherein loaded RCA occupies between approximately 10% and 50% of a volume of the chamber.

9. A method of carbonation of recycled concrete aggregates (RCA), the method comprising:
collecting, crushing, and screening waste concrete to create the RCA, the RCA being hardened concrete comprising natural aggregates bound together by cement paste, wherein the cement paste comprises calcium hydroxide and calcium silicate hydrate;
loading the RCA into a hermetically sealed chamber;
pressurizing an interior of the chamber with carbon dioxide gas;
monitoring a pressure, a temperature, and a relative humidity in the interior of the chamber;
controlling the pressure, the temperature, and the relative humidity until certain predetermined conditions are met;
meeting the predetermined conditions, comprising:
a) a treatment time less than approximately 12 hours, wherein the treatment time comprises exposure to pressurized carbon dioxide gas;
b) a pressure greater than 50 psig;
c) a temperature between approximately 0° C. and 80° C.; and
d) a relative humidity between approximately 10% and 75%;
wherein mechanical and chemical properties of the RCA are improved through the treatment.

10. The method of claim 9, wherein the predetermined conditions comprise:
the treatment time is between approximately 2 hours and 6 hours;
the pressure within the chamber is greater than 60 psig;
the temperature within the chamber is between approximately 20° C. and 30° C.; and
the relative humidity within the chamber is between approximately 40% and 60%.

11. The method of claim 9, further comprising pre-conditioning the RCA to have a moisture content between approximately 3% and 5% before loading the RCA into the chamber.

12. The method of claim 9, wherein the improved mechanical properties comprise at least one of:
an improvement in aggregate crushing value of at least approximately 10% as compared to untreated RCA;
an improvement in Los Angeles abrasion mass loss of at least approximately 10% as compared to untreated RCA; or
an improvement in freeze-thaw mass loss of at least approximately 20% as compared to untreated RCA.

13. The method of claim 9, wherein the improved chemical properties comprise at least one of:
a decrease in pH of leachate water of at least approximately one pH unit as compared to untreated RCA; or
a decrease in concentration of heavy metals in leachate water of at least approximately 50% as compared to untreated RCA.

14. The method of claim 9, further comprising continuously supplying carbon dioxide gas into the chamber to maintain the pressure in the chamber between approximately 20 psig and 80 psig.

15. The method of claim 9, further comprising purging the chamber before pressurizing the interior of the chamber to greater than 50 psig with carbon dioxide gas, the purging comprising:
applying a vacuum to evacuate the chamber; or
pressurizing the chamber with carbon dioxide gas at a low pressure of approximately 2 to 3 psig followed by releasing the pressure through an ejection valve.

16. A system for treating recycled concrete aggregates (RCA), the system comprising:
a chamber configured to form a hermetic seal, the chamber comprising:
a volume of at least 10 L and no greater than 3×10⁴ L; and
a door configured to form a hermetic seal;
at least one dehumidifier installed in the chamber and configured to maintain a relative humidity in the chamber;
at least one fan installed in the chamber and configured to circulate carbon dioxide gas and moisture within the chamber;
at least one heating element;
at least one pressure sensor installed and configured to measure a pressure within the chamber;
at least one relative humidity sensor installed and configured to measure a relative humidity within the chamber;
at least one temperature sensor installed and configured to measure a temperature within the chamber;
a supply of carbon dioxide gas operatively connected to the chamber via an injection valve;
an ejection valve installed on the chamber and configured to allow gas to exit the chamber;
the system configured to treat the RCA by exposure to carbon dioxide gas within the chamber, the chamber pressurized with the carbon dioxide gas; and
the system configured to monitor and control a pressure, a temperature and a relative humidity of the atmosphere inside the chamber during treatment of the RCA until certain predetermined conditions are met, the predetermined conditions comprising:
a) a treatment time less than approximately 12 hours, wherein the treatment time comprises exposure to pressurized carbon dioxide gas;
b) a pressure greater than 50 psig;
c) a temperature between approximately 0° C. and 80° C.; and
d) a relative humidity between approximately 10% and 75%;
wherein the system improves mechanical and chemical properties of the RCA through the treatment.

17. The system of claim 16, wherein the predetermined conditions comprise:
the treatment time is between approximately 2 hours and 6 hours;
the pressure within the chamber is greater than 60 psig;
the temperature within the chamber is between approximately 20° C. and 30° C.; and
the relative humidity within the chamber is between approximately 40% and 60%.

18. The system of claim 16, wherein the improved mechanical properties comprise at least one of:
an improvement in aggregate crushing value of at least approximately 10% as compared to untreated RCA;
an improvement in Los Angeles abrasion mass loss of at least approximately 10% as compared to untreated RCA; or
an improvement in freeze-thaw mass loss of at least approximately 20% as compared to untreated RCA.

19. The system of claim 16, wherein the improved chemical properties comprise at least one of:
a decrease in pH of leachate water of at least approximately one pH unit as compared to untreated RCA; or
a decrease in concentration of heavy metals in leachate water of at least approximately 50% as compared to untreated RCA.

20. The system of claim 16, wherein the treated RCA replaces at least 10% of natural aggregates in concrete mixed with the treated RCA.
